(19) United States
(12) Patent Application Publication
(10) Pub. No.: US 2025/0279872 A1
(43) Pub. Date: Sep. 4, 2025

(54) METHODS AND APPARATUSES FOR UPLINK TRANSMISSION

(71) Applicant: Telefonaktiebolaget LM Ericsson (publ), Stockholm (SE)

(72) Inventors: Zhipeng LIN, Nanjing (CN); Ling SU, Beijing (CN); Johan AXNÄS, Solna (SE); Robert Mark HARRISON, Grapevine, TX (US)

(73) Assignee: Telefonaktiebolaget LM Ericsson (publ), Stockholm (SE)

(21) Appl. No.: 18/249,242

(22) PCT Filed: Oct. 15, 2021
(86) PCT No.: PCT/CN2021/124173

§ 371 Date: Apr. 14, 2023

(30) Foreign Application Priority Data
Oct. 16, 2020 (WO) PCT/CN2020/121474

(51) Int. Cl. H04L 5/00; H04W 72/21

(52) U.S. Cl. CPC H04L 5/0098; H04W 72/21

(57) ABSTRACT

Methods and apparatuses for uplink transmission are disclosed. A terminal device receives, from a base station, a signaling about whether and/or how to perform coherent transmissions over time. The terminal device transmits, based on the received signaling, a first signal on a physical channel in a first time instant in a first set of subcarriers. The terminal device transmits, based on the received signaling, a second signal on the physical channel in a second time instant in a second set of subcarriers. The transmission in the first time instant and the transmission in the second time instant are coherent with each other.

### CROSS-REFERENCE TO RELATED APPLICATIONS

This application is a National stage of International Application No. PCT/CN2021/124173, filed Oct. 15, 2021, which claims priority to International Application No. PCT/CN2020/121474, filed Oct. 16, 2020, which are hereby incorporated by reference.

### TECHNICAL FIELD

Embodiments of the disclosure generally relate to communication, and, more particularly, to methods and apparatuses for uplink transmission.

### BACKGROUND

This section introduces aspects that may facilitate better understanding of the present disclosure. Accordingly, the statements of this section are to be read in this light and are not to be understood as admissions about what is in the prior art or what is not in the prior art.

Slot aggregation for physical uplink shared channel (PUSCH) is supported in new radio (NR) Release 15 (Rel-15) and renamed to PUSCH Repetition Type A in Rel-16. The name PUSCH repetition Type A is used even if there is only a single repetition, i.e. no slot aggregation. In Rel. 15, a PUSCH transmission that overlaps with downlink (DL) symbols is not transmitted, as specified below.
For DCI granted multi-slot transmission (PDSCH/PUSCH) vs semi-static DL/UL assignment
   If semi-static DL/UL assignment configuration of a slot has no direction confliction with scheduled PDSCH/PUSCH assigned symbols, the PDSCH/PUSCH in that slot is received/transmitted
   If semi-static DL/UL assignment configuration of a slot has direction confliction with scheduled PDSCH/PUSCH assigned symbols, the PDSCH/PUSCH transmission in that slot is not received/transmitted, i.e. the effective number of repetitions reduces

In Rel. 15, the number of repetitions is semi-statically configured by radio resource control (RRC) parameter pusch-AggregationFactor. At most 8 repetitions are supported, as defined below.
pusch-AggregationFactor ENUMERATED {n2, n4, n8}

Early termination of PUSCH repetitions was discussed in R14 NR SI in RAN1 #88 with below agreement, but not standardized finally.

R1-1703868, “WF on grant-free repetitions”, Huawei, HiSilicon, Nokia, ABS, ZTE, ZTE Microelectronics, CATT, Convida Wireless, CATR, OPPO, Inter Digital, Fujitsu.

### Agreements:

For UE configured with K repetitions for a TB transmission with/without grant, the UE can continue repetitions (FFS can be different RV versions, FFS different MCS) for the TB until one of the following conditions is met
   If an UL grant is successfully received for a slot/mini-slot for the same TB
      FFS: How to determine the grant is for the same TB
   FFS: An acknowledgement/indication of successful receiving of that TB from gNB
   The number of repetitions for that TB reaches K
   FFS: Whether it is possible to determine if the grant is for the same TB
   Note that this does not assume that UL grant is scheduled based on the slot whereas grant free allocation is based on mini-slot (vice versa)
      Note that other termination condition of repetition may apply.

A new repetition format PUSCH repetition Type B is supported in NR Rel-16. This type of PUSCH repetition allows back-to-back repetition of PUSCH transmissions. The biggest difference between the two types is that repetition Type A only allows a single repetition in each slot, with each repetition occupying the same symbols. Using this format with a PUSCH length shorter than 14 introduces gaps between repetitions, increasing the overall latency. The other change compared to Rel. 15 is how the number of repetitions is signaled. In Rel. 15, the number of repetitions is semi-statically configured, while in Rel. 16 the number of repetitions can be indicated dynamically in downlink control information (DCI). This applies both to dynamic grants and configured grants type 2.

In NR R16, invalid symbols for PUSCH repetition Type B include reserved uplink (UL) resources. The invalid symbol pattern indicator field is configured in the scheduling DCI. Segmentation occurs around symbols that are indicated as DL by the semi-static TDD pattern and invalid symbols.

The signaling of the number of repetitions is specified as below.

For PUSCH repetition Type A, when transmitting PUSCH scheduled by DCI format 0_1 or 0_2 in PDCCH with CRC scrambled with C-RNTI, MCS-C-RNTI, or CS-RNTI with NDI=1, the number of repetitions K is determined as
if numberofrepetitions is present in the resource allocation table, the number of repetitions K is equal to numberofrepetitions;
elseif the UE is configured with pusch-AggregationFactor, the number of repetitions K is equal to pusch-AggregationFactor;
otherwise K=1.

### Format DCI0_1 in 3GPP TS 38.212 V16.1.0:

Time domain resource assignment—0, 1, 2, 3, 4, 5, or 6 bits
If the higher layer parameter PUSCH-TimeDomainResourceAllocationList-ForDCIformat0_1 is not configured and if the higher layer parameter pusch-TimeDomainAllocationList is configured, 0, 1, 2, 3, or 4 bits as defined in Clause 6.1.2.1 of [6, TS38.214]. The bitwidth for this field is determined as ┌log₂ (I)┐ bits, where I is the number of entries in the higher layer parameter pusch-TimeDomainAllocationList or pusch-TimeDomainAllocationList-r16;
If the higher layer parameter PUSCH-TimeDomainResourceAllocationList-ForDCIformat0_1 is configured, 0, 1, 2, 3, 4, 5 or 6 bits as defined in Clause 6.1.2.1 of [6, TS38.214]. The bitwidth for this field is determined as ┌log₂ (I)┐ bits, where I is the number of entries in the higher layer parameter PUSCH-TimeDomainResourceAllocationList-ForDCIformat0_1;
otherwise the bitwidth for this field is determined as ┌log₂ (I)┐ bits, where I is the number of entries in the default table.

### From 3GPP TS 38.331 V16.1.0:

### PUSCH-Config Information Element

| | |
|---|---|
| pusch-TimeDomainAllocationList | SetupRelease { PUSCH- |

TimeDomainResourceAllocationList }

| | |
|---|---|
| pusch-AggregationFactor | ENUMERATED { n2, n4, n8 } |

OPTIONAL, -- Need S
pusch-TimeDomainAllocationListForDCI-Format0-1-r16 SetupRelease { PUSCH-
TimeDomainResourceAllocationList-r16 }
pusch-TimeDomainAllocationListForDCI-Format0-2-r16 SetupRelease { PUSCH-
TimeDomainResourceAllocationList-r16 }

### PUSCH-TimeDomainResourceAllocation Information Element

-- ASN1START
-- TAG-PUSCH-TIMEDOMAINRESOURCEALLOCATIONLIST-START

| | |
|---|---|
| PUSCH-TimeDomainResourceAllocationList ::= | SEQUENCE (SIZE(1..maxNrofUL-Allocations)) OF |

PUSCH-TimeDomainResourceAllocation

| | |
|---|---|
| PUSCH-TimeDomainResourceAllocation ::= | SEQUENCE { |
| k2 | INTEGER(0..32) |

OPTIONAL, -- Need S

| | |
|---|---|
| mappingType | ENUMERATED {typeA, typeB}, |
| startSymbolAndLength | INTEGER (0..127) |

}

| | |
|---|---|
| PUSCH-TimeDomainResourceAllocationList-r16 ::= | SEQUENCE (SIZE(1..maxNrofUL-Allocations- |

r16)) OF PUSCH-TimeDomainResourceAllocation-r16

| PUSCH-TimeDomainResourceAllocation-r16 ::= | SEQUENCE { | |
|---|---|---|
| k2-r16 | INTEGER(0..32) | OPTIONAL, -- |

Need S

| | |
|---|---|
| puschAllocationList-r16 | SEQUENCE (SIZE(1..maxNrofMultiplePUSCHs- |

r16)) OF PUSCH-Allocation-r16,
...
}
PUSCH-Allocation-r16 ::= SEQUENCE {

| | |
|---|---|
| mappingType-r16 | ENUMERATED {typeA, typeB} |

OPTIONAL, -- Cond NotFormat01-02-Or-TypeA

| | |
|---|---|
| startSymbolAndLength-r16 | INTEGER (0..127) |

OPTIONAL, -- Cond NotFormat01-02-Or-TypeA

| | |
|---|---|
| startSymbol-r16 | INTEGER (0..13) |

OPTIONAL, -- Cond RepTypeB

| | |
|---|---|
| length-r16 | INTEGER (1..14) |

OPTIONAL, -- Cond RepTypeB

| | |
|---|---|
| numberOfRepetitions-r16 | ENUMERATED {n1, n2, n3, n4, n7, n8, n12, |

n16} OPTIONAL, -- Cond Format01-02
...
}
-- TAG-PUSCH-TIMEDOMAINRESOURCEALLOCATIONLIST-STOP
-- ASN1STOP

| | | |
|---|---|---|
| maxNrofUL-Allocations | INTEGER ::= 16 | -- Maximum number of PUSCH |

time domain resource allocations.

| | | |
|---|---|---|
| maxNrofUL-Allocations-r16 | INTEGER ::= 64 | -- Maximum number of PUSCH |

time domain resource allocations

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for uplink transmission. In particular, one of the problems to be solved by the disclosure is that the reception performance of PUSCH may be poor in the existing solution.

According to a first aspect of the disclosure, there is provided a method performed by a terminal device. The method may comprise receiving, from a base station, a signaling about whether and/or how to perform coherent transmissions over time. The method may further comprise transmitting, based on the received signaling, a first signal on a physical channel in a first time instant in a first set of subcarriers. The method may further comprise transmitting, based on the received signaling, a second signal on the physical channel in a second time instant in a second set of subcarriers. The transmission in the first time instant and the transmission in the second time instant may be coherent with each other.

In this way, it is possible for a base station to improve the reception performance of the physical channel by utilizing the coherency between the transmissions.

In an embodiment of the disclosure, the second signal may be a repetition of the first transmitted signal.

In an embodiment of the disclosure, the transmission in the first time instant and the transmission in the second time instant may be performed on a same antenna port.

In an embodiment of the disclosure, the transmission in the first time instant and the transmission in the second time instant may be coherent with each other in terms of at least one of phase, transmission power and beam.

In an embodiment of the disclosure, the method may further comprise transmitting, to the base station, capability information of the terminal device regarding a support of the coherent transmissions over time.

In an embodiment of the disclosure, the capability information may indicate at least one of: a number of time instants over which the terminal device is capable of supporting the coherent transmissions over time; and a condition under which the terminal device is capable of supporting the coherent transmissions over time.

In an embodiment of the disclosure, the condition may be related to one or more of following factors: allocated frequency resource; hopping frequency; transmission power; uplink transmission beam or spatial transmission filter; phase rotation; subcarrier spacing; demodulation reference signal (DMRS) configuration; a number of repetitions of the first transmitted signal; and a speed of the terminal device.

In an embodiment of the disclosure, the received signaling may indicate one or more of: whether to perform the coherent transmissions over time; in which time instants the coherent transmissions over time are to be performed; a number of contiguous time instants in which the coherent transmissions over time are to be performed; and at least one parameter with which the coherent transmissions over time are to be performed.

In an embodiment of the disclosure, a difference in phase and/or a difference in phase error and/or an error of phase difference between each of the subcarriers in the second set and each of the subcarriers in the first set may be smaller than or equal to a predetermined threshold.

In an embodiment of the disclosure, the transmission in the first time instant and the transmission in the second time instant may be performed with at least one of: a same transmission power; a same spatial transmission filter; and a same uplink precoder.

In an embodiment of the disclosure, the terminal device may be scheduled on a plurality of carriers. The first set of subcarriers and the second set of subcarriers may belong to a same carrier/carrier group or neighboring carriers/carrier groups.

In an embodiment of the disclosure, a number of the first set of subcarriers may be the same as a number of the second set of subcarriers.

In an embodiment of the disclosure, the first set of subcarriers may be the same as the second set of subcarriers.

In an embodiment of the disclosure, the second time instant may immediately follow the first time instant.

In an embodiment of the disclosure, each of the first time instant and the second time instant may be a slot or a sub-slot.

In an embodiment of the disclosure, the transmission in the first time instant and the transmission in the second time instant may be scheduled with a dynamic grant, or with a configured grant, or separately with independent grants.

In an embodiment of the disclosure, the method may further comprise providing user data and forwarding the user data to a host computer via the transmission to the base station.

According to a second aspect of the disclosure, there is provided a method performed by a base station. The method may comprise transmitting, to a terminal device, a signaling about whether and/or how to perform coherent transmissions over time. The method may further comprise receiving, from the terminal device, a first uplink transmission of a first signal on a physical channel in a first time instant in a first set of subcarriers, based on the transmitted signaling. The method may further comprise receiving, from the terminal device, a second uplink transmission of a second signal on the physical channel in a second time instant in a second set of subcarriers, based on the transmitted signaling. The first uplink transmission and the second uplink transmission may be coherent with each other. The method may further comprise processing the first and second uplink transmissions based on the coherency between the first and second uplink transmissions.

In this way, the base station can improve the reception performance of the physical channel by utilizing the coherency between the uplink transmissions.

In an embodiment of the disclosure, the second signal may be a repetition of the first signal.

In an embodiment of the disclosure, the first uplink transmission and the second uplink transmission may be from a same antenna port of the terminal device.

In an embodiment of the disclosure, processing the first and second uplink transmissions may comprise performing a joint channel estimation for the first and second uplink transmissions. Processing the first and second uplink transmissions may further comprise decoding a payload of the first signal and/or the second signal based on a result of the joint channel estimation.

In an embodiment of the disclosure, the first uplink transmission and the second uplink transmission may be coherent with each other in terms of at least one of phase, transmission power and beam.

In an embodiment of the disclosure, the method may further comprise receiving, from the terminal device, capability information of the terminal device regarding a support of the coherent transmissions over time.

In an embodiment of the disclosure, the capability information may indicate at least one of: a number of time instants over which the terminal device is capable of supporting the coherent transmissions over time; and a condition under which the terminal device is capable of supporting the coherent transmissions over time.

In an embodiment of the disclosure, the condition may be related to one or more of following factors: allocated frequency resource; hopping frequency; transmission power; uplink transmission beam or spatial transmission filter; phase rotation; subcarrier spacing; DMRS configuration; a number of repetitions of the first signal; and a speed of the terminal device.

In an embodiment of the disclosure, the transmitted signaling may indicate one or more of: whether to perform the coherent transmissions over time; in which time instants the coherent transmissions over time are to be performed; a number of contiguous time instants in which the coherent transmissions over time are to be performed; and at least one parameter with which the coherent transmissions over time are to be performed.

In an embodiment of the disclosure, the at least one parameter may comprise one or more of: a same transmission power; a same spatial transmission filter; and a same uplink precoder.

In an embodiment of the disclosure, a difference in phase and/or a difference in phase error and/or an error of phase difference between each of the subcarriers in the second set and each of the subcarriers in the first set may be smaller than or equal to a predetermined threshold.

In an embodiment of the disclosure, the terminal device may be scheduled on a plurality of carriers. The first set of subcarriers and the second set of subcarriers may belong to a same carrier/carrier group or neighboring carriers/carrier groups.

In an embodiment of the disclosure, a number of the first set of subcarriers may be the same as a number of the second set of subcarriers.

In an embodiment of the disclosure, the first set of subcarriers may be the same as the second set of subcarriers.

In an embodiment of the disclosure, the second time instant may immediately follow the first time instant.

In an embodiment of the disclosure, each of the first time instant and the second time instant may be a slot or a sub-slot.

In an embodiment of the disclosure, the first uplink transmission and the second uplink transmission may be scheduled with a dynamic grant, or with a configured grant, or separately with independent grants.

According to a third aspect of the disclosure, there is provided a method performed by a terminal device. The method may comprise determining a frequency hopping pattern for an uplink transmission, based on a signaling received from a base station. The method may further comprise transmitting a plurality of signals on a physical channel in a plurality of time instants based on the frequency hopping pattern.

In this way, it is possible to be more robust to interference.

In an embodiment of the disclosure, the plurality of signals may be repetitions of each other.

In an embodiment of the disclosure, the signaling may be a cell specific signaling or a signaling dedicated for the terminal device.

In an embodiment of the disclosure, the signaling may be a random access response that is extended with a first parameter indicating an index by which the frequency hopping pattern can be determined from a predetermined table. The predetermined table may indicate correspondences between multiple predetermined frequency hopping patterns and multiple predetermined indexes.

In an embodiment of the disclosure, the signaling may be a random access response that is extended with a second parameter serving as an input to a predetermined function for determining the frequency hopping pattern.

In an embodiment of the disclosure, the signaling may indicate a physical random access channel (PRACH) configuration for random access. The frequency hopping pattern may be determined based on the PRACH configuration.

In an embodiment of the disclosure, the signaling may indicate an identity (ID) of a cell serving the terminal device. The frequency hopping pattern may be determined based on the ID of the cell.

In an embodiment of the disclosure, the method may further comprise providing user data and forwarding the user data to a host computer via the transmission to the base station.

According to a fourth aspect of the disclosure, there is provided a method performed by a base station. The method may comprise transmitting, to a terminal device, a signaling by which a frequency hopping pattern for an uplink transmission can be determined. The method may further comprise receiving, from the terminal device, a plurality of signals on a physical channel in a plurality of time instants based on the frequency hopping pattern.

In this way, it is possible to be more robust to interference.

In an embodiment of the disclosure, the plurality of signals may be repetitions of each other.

In an embodiment of the disclosure, the signaling may be a cell specific signaling or a signaling dedicated for the terminal device.

In an embodiment of the disclosure, the signaling may be a random access response that is extended with a first parameter indicating an index by which the frequency hopping pattern can be determined from a predetermined table. The predetermined table may indicate correspondences between multiple predetermined frequency hopping patterns and multiple predetermined indexes.

In an embodiment of the disclosure, the signaling may be a random access response that is extended with a second parameter serving as an input to a predetermined function for determining the frequency hopping pattern.

In an embodiment of the disclosure, the signaling may indicate a PRACH configuration for random access. The frequency hopping pattern can be determined based on the PRACH configuration.

In an embodiment of the disclosure, the signaling may indicate an ID of a cell serving the terminal device. The frequency hopping pattern can be determined based on the ID of the cell.

According to a fifth aspect of the disclosure, there is provided a method performed by a terminal device. The method may comprise receiving, from a base station, a signaling indicating DMRS configurations for an uplink transmission that is to be performed in multiple time instants. The DMRS configurations may indicate that a number of DMRS symbols to be transmitted in part of the multiple time instants is zero or less than normal. The method may further comprise transmitting multiple signals on a physical channel in the multiple time instants. The method may further comprise transmitting DMRS symbols on the physical channel based on the DMRS configurations.

In this way, the overhead of DMRS symbols can be reduced.

In an embodiment of the disclosure, the multiple signals may be repetitions of each other.

In an embodiment of the disclosure, the DMRS configurations may be indicated as a bitmap of time instants.

In an embodiment of the disclosure, the signaling may be a radio resource control (RRC) signaling or a downlink control information (DCI) signaling.

In an embodiment of the disclosure, the transmission of the multiple signals and the transmission of the DMRS symbols may be performed with a same total length of the physical channel for different time instants.

In an embodiment of the disclosure, different transport block size (TBS) determinations may be performed for the time instants having different DMRS configurations. Alternatively, a same TBS determination may be performed for the multiple time instants and separate adaptations may be performed for the time instants having different DMRS configurations.

In an embodiment of the disclosure, the transmission of the multiple signals and the transmission of the DMRS symbols may be performed with different total lengths of the physical channel for the time instants having different DMRS configurations.

In an embodiment of the disclosure, a same TBS determination may be performed for the multiple time instants. Alternatively, different TBS determinations may be performed for the time instants having different DMRS configurations.

In an embodiment of the disclosure, the method may further comprise providing user data and forwarding the user data to a host computer via the transmission to the base station.

According to a sixth aspect of the disclosure, there is provided a method performed by a base station. The method may comprise transmitting, to a terminal device, a signaling indicating DMRS configurations for an uplink transmission that is to be performed in multiple time instants. The DMRS configurations may indicate that a number of DMRS symbols to be transmitted in part of the multiple time instants is zero or less than normal. The method may further comprise receiving multiple signals on a physical channel in the multiple time instants. The method may further comprise receiving DMRS symbols on the physical channel based on the DMRS configurations.

In this way, the overhead of DMRS symbols can be reduced.

In an embodiment of the disclosure, the multiple signals may be repetitions of each other.

In an embodiment of the disclosure, the DMRS configurations may be indicated as a bitmap of time instants.

In an embodiment of the disclosure, the signaling may be an RRC signaling or a DCI signaling.

In an embodiment of the disclosure, the multiple signals and the DMRS symbols may be received with a same total length of the physical channel for different time instants.

In an embodiment of the disclosure, the multiple signals and the DMRS symbols may be received with different total lengths of the physical channel for the time instants having different DMRS configurations.

According to a seventh aspect of the disclosure, there is provided a terminal device. The terminal device may comprise at least one processor and at least one memory. The at least one memory may contain instructions executable by the at least one processor, whereby the terminal device may be operative to receive, from a base station, a signaling about whether and/or how to perform coherent transmissions over time. The terminal device may be further operative to transmit, based on the received signaling, a first signal on a physical channel in a first time instant in a first set of subcarriers. The terminal device may be further operative to transmit, based on the received signaling, a second signal on the physical channel in a second time instant in a second set of subcarriers. The transmission in the first time instant and the transmission in the second time instant may be coherent with each other.

In an embodiment of the disclosure, the terminal device may be operative to perform the method according to the above first aspect.

According to an eighth aspect of the disclosure, there is provided a base station. The base station may comprise at least one processor and at least one memory. The at least one memory may contain instructions executable by the at least one processor, whereby the base station may be operative to transmit, to a terminal device, a signaling about whether and/or how to perform coherent transmissions over time. The base station may be further operative to receive, from the terminal device, a first uplink transmission of a first signal on a physical channel in a first time instant in a first set of subcarriers, based on the transmitted signaling. The base station may be further operative to receive, from the terminal device, a second uplink transmission of a second signal on the physical channel in a second time instant in a second set of subcarriers, based on the transmitted signaling. The first uplink transmission and the second uplink transmission may be coherent with each other. The base station may be further operative to process the first and second uplink transmissions based on the coherency between the first and second uplink transmissions.

In an embodiment of the disclosure, the base station may be operative to perform the method according to the above second aspect.

According to a ninth aspect of the disclosure, there is provided a terminal device. The terminal device may comprise at least one processor and at least one memory. The at least one memory may contain instructions executable by the at least one processor, whereby the terminal device may be operative to determine a frequency hopping pattern for an uplink transmission, based on a signaling received from a base station. The terminal device may be further operative to transmit a plurality of signals on a physical channel in a plurality of time instants based on the frequency hopping pattern.

In an embodiment of the disclosure, the terminal device may be operative to perform the method according to the above third aspect.

According to a tenth aspect of the disclosure, there is provided a base station. The base station may comprise at least one processor and at least one memory. The at least one memory may contain instructions executable by the at least one processor, whereby the base station may be operative to transmit, to a terminal device, a signaling by which a frequency hopping pattern for an uplink transmission can be determined. The base station may be further operative to receive, from the terminal device, a plurality of signals on a physical channel in a plurality of time instants based on the frequency hopping pattern.

In an embodiment of the disclosure, the base station may be operative to perform the method according to the above fourth aspect.

According to an eleventh aspect of the disclosure, there is provided a terminal device. The terminal device may comprise at least one processor and at least one memory. The at least one memory may contain instructions executable by the at least one processor, whereby the terminal device may be operative to receive, from a base station, a signaling indicating DMRS configurations for an uplink transmission that is to be performed in multiple time instants. The DMRS configurations may indicate that a number of DMRS symbols to be transmitted in part of the multiple time instants is zero or less than normal. The terminal device may be further operative to transmit multiple signals on a physical channel in the multiple time instants. The terminal device may be further operative to transmit DMRS symbols on the physical channel based on the DMRS configurations.

In an embodiment of the disclosure, the terminal device may be operative to perform the method according to the above fifth aspect.

According to a twelfth aspect of the disclosure, there is provided a base station. The base station may comprise at least one processor and at least one memory. The at least one memory may contain instructions executable by the at least one processor, whereby the base station may be operative to transmit, to a terminal device, a signaling indicating DMRS configurations for an uplink transmission that is to be performed in multiple time instants. The DMRS configurations may indicate that a number of DMRS symbols to be transmitted in part of the multiple time instants is zero or less than normal. The base station may be further operative to receive multiple signals on a physical channel in the multiple time instants. The base station may be further operative to receive DMRS symbols on the physical channel based on the DMRS configurations.

In an embodiment of the disclosure, the base station may be operative to perform the method according to the above sixth aspect.

According to a thirteenth aspect of the disclosure, there is provided a computer program product. The computer program product may comprise instructions which when executed by at least one processor, cause the at least one processor to perform the method according to any of the above first to sixth aspects.

According to a fourteenth aspect of the disclosure, there is provided a computer readable storage medium. The computer readable storage medium may comprise instructions which when executed by at least one processor, cause the at least one processor to perform the method according to any of the above first to sixth aspects.

According to a fifteenth aspect of the disclosure, there is provided a terminal device. The terminal device may comprise a reception module for receiving, from a base station, a signaling about whether and/or how to perform coherent transmissions over time. The terminal device may further comprise a first transmission module for transmitting, based on the received signaling, a first signal on a physical channel in a first time instant in a first set of subcarriers. The terminal device may further comprise a second transmission module for transmitting, based on the received signaling, a second signal on the physical channel in a second time instant in a second set of subcarriers. The transmission in the first time instant and the transmission in the second time instant may be coherent with each other.

According to a sixteenth aspect of the disclosure, there is provided a base station. The base station may comprise a transmission module for transmitting, to a terminal device, a signaling about whether and/or how to perform coherent transmissions over time. The base station may further comprise a first reception module for receiving, from the terminal device, a first uplink transmission of a first signal on a physical channel in a first time instant in a first set of subcarriers, based on the transmitted signaling. The base station may further comprise a second reception module for receiving, from the terminal device, a second uplink transmission of a second signal on the physical channel in a second time instant in a second set of subcarriers, based on the transmitted signaling. The first uplink transmission and the second uplink transmission may be coherent with each other. The base station may further comprise a processing module for processing the first and second uplink transmissions based on the coherency between the first and second uplink transmissions.

According to a seventeenth aspect of the disclosure, there is provided a terminal device. The terminal device may comprise a determination module for determining a frequency hopping pattern for an uplink transmission, based on a signaling received from a base station. The terminal device may further comprise a transmission module for transmitting a plurality of signals on a physical channel in a plurality of time instants based on the frequency hopping pattern.

According to an eighteenth aspect of the disclosure, there is provided a base station. The base station may comprise a transmission module for transmitting, to a terminal device, a signaling by which a frequency hopping pattern for an uplink transmission can be determined. The base station may further comprise a reception module for receiving, from the terminal device, a plurality of signals on a physical channel in a plurality of time instants based on the frequency hopping pattern.

According to a nineteenth aspect of the disclosure, there is provided a terminal device. The terminal device may comprise a reception module for receiving, from a base station, a signaling indicating DMRS configurations for an uplink transmission that is to be performed in multiple time instants. The DMRS configurations may indicate that a number of DMRS symbols to be transmitted in part of the multiple time instants is zero or less than normal. The terminal device may further comprise a first transmission module for transmitting multiple signals on a physical channel in the multiple time instants. The terminal device may further comprise a second transmission module for transmitting DMRS symbols on the physical channel based on the DMRS configurations.

According to a twentieth aspect of the disclosure, there is provided a base station. The base station may comprise a transmission module for transmitting, to a terminal device, a signaling indicating DMRS configurations for an uplink transmission that is to be performed in multiple time instants. The DMRS configurations may indicate that a number of DMRS symbols to be transmitted in part of the multiple time instants is zero or less than normal. The base station may further comprise a first reception module for receiving multiple signals on a physical channel in the multiple time instants. The base station may further comprise a second reception module for receiving DMRS symbols on the physical channel based on the DMRS configurations.

According to a twenty-first aspect of the disclosure, there is provided a method implemented in a communication system including a terminal device and a base station. The method may comprise steps of the methods according to the above first and second aspects.

According to a twenty-second aspect of the disclosure, there is provided a communication system including a terminal device according to the above seventh or fifteenth aspect and a base station according to the above eighth or sixteenth aspect.

According to a twenty-third aspect of the disclosure, there is provided a method implemented in a communication system including a terminal device and a base station. The method may comprise steps of the methods according to the above third and fourth aspects.

According to a twenty-fourth aspect of the disclosure, there is provided a communication system including a terminal device according to the above ninth or seventeenth aspect and a base station according to the above tenth or eighteenth aspect.

According to a twenty-fifth aspect of the disclosure, there is provided a method implemented in a communication system including a terminal device and a base station. The method may comprise steps of the methods according to the above fifth and sixth aspects.

According to a twenty-sixth aspect of the disclosure, there is provided a communication system including a terminal device according to the above eleventh or nineteenth aspect and a base station according to the above twelfth or twentieth aspect.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIGS. 1A-1C are diagrams illustrating examples of frequency hopping patterns;

FIGS. 2A-2B are diagrams illustrating examples of frequency hopping patterns;

FIG. 3 is a diagram illustrating the simulated performance for the frequency hopping patterns of FIGS. 1A-1C;

FIG. 4 is a diagram illustrating an embodiment of the disclosure;

FIGS. 5A-5C are diagrams illustrating some embodiments of the disclosure;

FIG. 6 is a flowchart illustrating a method performed by a terminal device according to an embodiment of the disclosure;

FIG. 7 is a flowchart illustrating a method performed by a terminal device according to another embodiment of the disclosure;

FIG. 8 is a flowchart illustrating a method performed by a base station according to an embodiment of the disclosure;

FIG. 9 is a flowchart for explaining the method of FIG. 8;

FIG. 10 is a flowchart illustrating a method performed by a base station according to another embodiment of the disclosure;

FIG. 11 is a flowchart illustrating a method performed by a terminal device according to an embodiment of the disclosure;

FIG. 12 is a flowchart illustrating a method performed by a base station according to an embodiment of the disclosure;

FIG. 13 is a flowchart illustrating a method performed by a terminal device according to an embodiment of the disclosure;

FIG. 14 is a flowchart illustrating a method performed by a base station according to an embodiment of the disclosure;

FIG. 15 is a block diagram showing an apparatus suitable for use in practicing some embodiments of the disclosure;

FIG. 16 is a block diagram showing a terminal device according to an embodiment of the disclosure;

FIG. 17 is a block diagram showing a base station according to an embodiment of the disclosure;

FIG. 18 is a block diagram showing a terminal device according to an embodiment of the disclosure;

FIG. 19 is a block diagram showing a base station according to an embodiment of the disclosure;

FIG. 20 is a block diagram showing a terminal device according to an embodiment of the disclosure;

FIG. 21 is a block diagram showing a base station according to an embodiment of the disclosure;

FIG. 22 is a diagram showing a telecommunication network connected via an intermediate network to a host computer in accordance with some embodiments;

FIG. 23 is a diagram showing a host computer communicating via a base station with a user equipment in accordance with some embodiments;

FIG. 24 is a flowchart illustrating a method implemented in a communication system in accordance with some embodiments;

FIG. 25 is a flowchart illustrating a method implemented in a communication system in accordance with some embodiments;

FIG. 26 is a flowchart illustrating a method implemented in a communication system in accordance with some embodiments; and

FIG. 27 is a flowchart illustrating a method implemented in a communication system in accordance with some embodiments.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

Type 1 and type 2 UL transmission with configured grant were supported in Rel-15. Type 1 UL data transmission with configured grant is only based on RRC (re)configuration without any layer 1 (L1) signaling and Type 2 is based on both RRC configuration and L1 signaling for activation/deactivation of the grant. For both types, radio network tempory identity(ies) (RNTI(s)) is/are configured by user equipment (UE)-specific RRC signaling. Within each type, an RNTI is configured by UE-specific RRC signaling at least for one resource configuration in a serving cell. PUSCH repetition with configured grant was supported.

NR supports multiple hybrid automatic repeat request (HARQ) processes for UL transmission with configured grant. When an UL grant is used for retransmissions of Type 1 UL transmission with configured grant, different RNTI from the RNTI for UL transmission with dynamic grant is needed. For Type 2 UL transmission with configured grant, different RNTI from the RNTI for UL transmission with dynamic grant is needed for activation/deactivation and at least for re-transmission. Acknowledgment (ACK) feedback is implicit and non-acknowledgment (NACK) is explicit. A timer T starts when a transport block (TB) is transmitted, and if no explicit NACK (dynamic grant) is received before the timer expires, the UE assumes ACK.

Related contents from Chapters 5.4.1, 5.4.2 and 5.8.2 of 3rd generation partnership project (3GPP) technical specification (TS) 38.321 f80 are as follows:

If the MAC entity has a C-RNTI, a Temporary C-RNTI, or CS-RNTI, the MAC entity shall for each PDCCH occasion and for each Serving Cell belonging to a TAG that has a running timeAlignmentTimer and for each grant received for this PDCCH occasion:
1> if an uplink grant for this Serving Cell has been received on the PDCCH for the MAC entity's C-RNTI or Temporary C-RNTI; or
1> if an uplink grant has been received in a Random Access Response:
   2> if the uplink grant is for MAC entity's C-RNTI and if the previous uplink grant delivered to the HARQ entity for the same HARQ process was either an uplink grant received for the MAC entity's CS-RNTI or a configured uplink grant:
      3> consider the NDI to have been toggled for the corresponding HARQ process regardless of the value of the NDI.
   2> if the uplink grant is for MAC entity's C-RNTI, and the identified HARQ process is configured for a configured uplink grant:
      3> start or restart the configuredGrantTimer for the corresponding HARQ process, if configured.
      3> stop the cg-RetransmissionTimer for the corresponding HARQ process, if running.
   2> deliver the uplink grant and the associated HARQ information to the HARQ entity.
1> else if an uplink grant for this PDCCH occasion has been received for this Serving Cell on the PDCCH for the MAC entity's CS-RNTI:
   2> if the NDI in the received HARQ information is 1:
      3> consider the NDI for the corresponding HARQ process not to have been toggled;
      3> start or restart the configuredGrantTimer for the corresponding HARQ process, if configured;
      3> stop the cg-RetransmissionTimer for the corresponding HARQ process, if running;
      3> deliver the uplink grant and the associated HARQ information to the HARQ entity.
   2> else if the NDI in the received HARQ information is 0:
      3> if PDCCH contents indicate configured grant Type 2 deactivation:
         4> trigger configured uplink grant confirmation.
      3> else if PDCCH contents indicate configured grant Type 2 activation:
         4> trigger configured uplink grant confirmation;
         4> store the uplink grant for this Serving Cell and the associated HARQ information as configured uplink grant;
         4> initialise or re-initialise the configured uplink grant for this Serving Cell to start in the associated PUSCH duration and to recur according to rules in clause 5.8.2;
         4> stop the configuredGrantTimer for the corresponding HARQ process, if running;
         4> stop the cg-RetransmissionTimer for the corresponding HARQ process, if running.

### #HARQ Process ID

For configured uplink grants neither configured with harq-ProcID-Offset2 nor with cg-RetransmissionTimer, the HARQ Process ID associated with the first symbol of a UL transmission is derived from the following equation:

HARQ Process ID=[floor(CURRENT_symbol/periodicity)] modulo nrofHARQ-Processes

For configured uplink grants with harq-ProcID-Offset2, the HARQ Process ID associated with the first symbol of a UL transmission is derived from the following equation:

HARQ Process ID=[floor(CURRENT_symbol/periodicity)] modulo nrofHARQ-Processes+harq-ProcID-Offset2

where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in TS 38.211 [8]. For configured uplink grants configured with cg-RetransmissionTimer, the UE implementation select an HARQ Process ID among the HARQ process IDs available for the configured grant configuration. The UE shall prioritize retransmissions before initial transmissions. The UE shall toggle the NDI in the CG-UCI for new transmissions and not toggle the NDI in the CG-UCI in retransmissions.
NOTE 1: CURRENT_symbol refers to the symbol index of the first transmission occasion of a repetition bundle that takes place.
NOTE 2: A HARQ process is configured for a configured uplink grant where harq-ProcID-Offset2 is not configured, if the configured uplink grant is activated and the associated HARQ process ID is less than nrofHARQ-Processes. A HARQ process is configured for a configured uplink grant where harq-ProcID-Offset2 is configured, if the configured uplink grant is activated and the associated HARQ process ID is greater than or equal to harq-ProcID-Offset2 and less than sum of harq-ProcID-Offset2 and nrofHARQ-Processes for the configured grant configuration.
NOTE 3: If the MAC entity receives a grant in a Random Access Response (i.e. MAC RAR or fallbackRAR) or determines a grant as specified in clause 5.1.2a for MSGA payload and if the MAC entity also receives an overlapping grant for its C-RNTI or CS-RNTI, requiring concurrent transmissions on the SpCell, the MAC entity may choose to continue with either the grant for its RA-RNTI/MSGB-RNTI/the MSGA payload transmission or the grant for its C-RNTI or CS-RNTI.
NOTE 4: In case of unaligned SFN across carriers in a cell group, the SFN of the concerned Serving Cell is used to calculate the HARQ Process ID used for configured uplink grants.
NOTE 5: A HARQ process is not shared between different configured grant configurations.

### #RRC Configuration for Type1/2 Configured Grant

RRC configures the following parameters when the configured grant Type 1 is configured:
cs-RNTI: CS-RNTI for retransmission;
periodicity: periodicity of the configured grant Type 1;
timeDomainOffset: Offset of a resource with respect to SFN=0 in time domain;
timeDomainAllocation: Allocation of configured uplink grant in time domain which contains startSymbolAndLength (i.e. SLIV in TS 38.214 [7]);
nrofHARQ-Processes: the number of HARQ processes for configured grant.
   RRC configures the following parameters when the configured grant Type 2 is configured:
cs-RNTI: CS-RNTI for activation, deactivation, and retransmission;
periodicity: periodicity of the configured grant Type 2;
nrofHARQ-Processes: the number of HARQ processes for configured grant.
   RRC configures the following parameters when retransmissions on configured uplink grant is configured:
cg-RetransmissionTimer: the duration after a configured grant (re)transmission of a HARQ process when the UE shall not autonomously retransmit that HARQ process.
   Retransmissions except for repetition of configured uplink grants use uplink grants addressed to CS-RNTI.

In NR up to Rel-16, different frequency hopping (FH) types are supported for multi-slot PUSCH. More specifically, intra-slot and inter-slot FH are supported for PUSCH repetition Type A. Inter-slot and inter-repetition FH are supported for repetition Type B. The two types of PUSCH repetition apply to PUSCH with dynamic grant and Type-1/2 configured grant. Indication on if frequency hopping is enabled, type of frequency hopping and frequency hopping offset lists are RRC configured. For PUSCH with dynamic grant and Type 2 configured grant, DCI field Frequency hopping flag further activates FH and frequency domain resource assignment (FDRA) indicates one offset list. For Type 1 configured grant PUSCH, frequency hopping activation and one frequency hopping offset is RRC configured.

The number of configurable frequency hopping offsets depends on bandwidth part (BWP) size, with four at maximum. When the size of the active BWP is less than 50 physical resource blocks (PRBs), one of two higher layer configured offsets is indicated in the UL grant. When the size of the active BWP is equal to or greater than 50 PRBs, one of four higher layer configured offsets is indicated in the UL grant.

For PUSCH repetition Type A, the determination of the starting resource block (RB) is described in 3GPP TS 38.214 as below.
In case of intra-slot frequency hopping, the starting RB in each hop is given by:

$${RB}_{start} = \{ \begin{matrix}{RB}_{start} & i = 0 \\ ( {RB}_{start} + {RB}_{offset} ) mod {N}_{BWP}^{size} & i = 1\end{matrix} ,$$

where i=0 and i=1 are the first hop and the second hop respectively, and RBₛₜₐᵣₜ is the starting RB within the UL BWP, as calculated from the resource block assignment information of resource allocation type 1 (described in Clause 6.1.2.2.2) or as calculated from the resource assignment for MsgA PUSCH (described in [6, TS 38.213]) and RB_{offset} is the frequency offset in RBs between the two frequency hops. The number of symbols in the first hop is given by └N_{symb}^{PUSCHs}/2┘, the number of symbols in the second hop is given by N_{symb}^{PUSCHs}−└N_{symb}^{PUSCHs}/2┘, where N_{symb}^{PUSCH,s} is the length of the PUSCH transmission in OFDM symbols in one slot.
In case of inter-slot frequency hopping, the starting RB during slot an is given by:

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} ,$$

where nₛ^{μ} is the current slot number within a radio frame, where a multi-slot PUSCH transmission can take place, RBₛₜₐᵣₜ is the starting RB within the UL BWP, as calculated from the resource block assignment information of resource allocation type 1 (described in Clause 6.1.2.2.2) and RB_{offset} is the frequency offset in RBs between the two frequency hops.

PUSCH repetition Type B supports inter-repetition FH and inter-slot FH. Inter-repetition FH is per nominal repetition. For PUSCH repetition Type B, the determination of the starting RB is described in 3GPP TS 38.214 as below.
In case of inter-repetition frequency hopping, the starting RB for an actual repetition within the n-th nominal repetition (as defined in Clause 6.1.2.1) is given by:

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} ,$$

where RBₛₜₐᵣₜ is the starting RB within the UL BWP, as calculated from the resource block assignment information of resource allocation type 1 (described in Clause 6.1.2.2.2) and RB_{offset} is the frequency offset in RBs between the two frequency hops.

With respect to frequency hopping signaling, related contents from 3GPP TS 38.331 v16.1.0 are as follows.

### Pusch-Config Information Element

| | |
|---|---|
| PUSCH-Config ::= | SEQUENCE { |
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks−1)
OPTIONAL, -- Need M

| | |
|---|---|
| frequencyHoppingForDCI-Format0-2-r16 | CHOICE { |
| pusch-RepTypeA | ENUMERATED {intraSlot, |

interSlot},

| | |
|---|---|
| pusch-RepTypeB | ENUMERATED |

```
{interRepetition, interSlot}
  }
OPTIONAL, -- Need S
  frequencyHoppingOffsetListsForDCI-Format0-2-r16 SetupRelease {
```

| | |
|---|---|
| FrequencyHoppingOffsetListsForDCI-Format0-2-r16} OPTIONAL, | -- Need M |

| | |
|---|---|
| frequencyHoppingForDCI-Format0-1-r16 | ENUMERATED {interRepetition, interSlot} |

OPTIONAL, -- Cond RepTypeB
}
FrequencyHoppingOffsetListsForDCI-Format0-2-r16 ::= SEQUENCE (SIZE (1..4)) OF INTEGER
(1.. maxNrofPhysicalResourceBlocks−1)

frequencyHopping
The value intraSlot enables ‘Intra-slot frequency hopping’ and the value interSlot enables ‘Inter-slot frequency
hopping’. If the field is absent, frequency hopping is not configured for ‘pusch-RepTypeA’ (see TS 38.214
[19], clause 6.3). The field frequencyHopping applies to DCI format 0_0 and 0_1 for ‘pusch-RepTypeA’.
frequencyHoppingForDCI-Format0-1
Indicates the frequency hopping scheme for DCI format 0_1 when pusch-RepTypeIndicatorForDCI-Format0-1
is set to ‘pusch-RepTypeB’, The value interRepetition enables ‘Inter-repetition frequency hopping’, and the
value interSlot enables ‘Inter-slot frequency hopping’. If the field is absent, frequency hopping is not
configured for DCI format 0_1 (see TS 38.214 [19], clause 6.1).
frequencyHoppingForDCI-Format0-2
Indicate the frequency hopping scheme for DCI format 0_2. The value intraSlot enables ‘intra-slot frequency
hopping’, and the value interRepetition enables ‘Inter-repetition frequency hopping’, and the value interSlot
enables ‘Inter-slot frequency hopping’. When pusch-RepTypeIndicatorForDCI-Format0-2 is set to ‘pusch-
RepTypeA’, the frequency hopping scheme can be chosen between ‘intra-slot frequency hopping and ‘inter-
slot frequency hopping’ if enabled. When pusch-RepTypeIndicatorForDCI-Format0-2 is set to ‘pusch-
RepTypeB’, the frequency hopping scheme can be chosen between ‘inter-repetition frequency hopping’ and
‘inter-slot frequency hopping’ if enabled. If the field is absent, frequency hopping is not configured for DCI
format 0_2 for ‘pusch-RepTypeB’ (see TS 38.214 [19], clause 6.3).
frequencyHoppingOffsetLists, frequencyHoppingOffsetListsForDCI-Format0-2
Set of frequency hopping offsets used when frequency hopping is enabled for granted transmission (not
msg3) and type 2 configured grant activation (see TS 38.214 [19], clause 6.3). The field
frequencyHoppingOffsetLists applies to DCI format 0_0 and DCI format 0_1 and the field
frequencyHoppingOffsetListsForDCI-Format0-2 applies to DCI format 0_2 (see TS 38.214 [19], clause 6.3).

### ConfiguredGrantConfig Information Element

-- ASN1START
-- TAG-CONFIGUREDGRANTCONFIG-START

| | |
|---|---|
| ConfiguredGrantConfig ::= | SEQUENCE { |
| frequencyHopping | ENUMERATED {intraSlot, interSlot} |

OPTIONAL, -- Need S

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. maxNrofPhysicalResourceBlocks−1) |

OPTIONAL, -- Need R

| | |
|---|---|
| pathlossReferenceIndex | INTEGER (0..maxNrofPUSCH- |

```
PathlossReferenceRSs−1),
    ...,
    [[
```

| | |
|---|---|
| pusch-RepTypeIndicator-r16 | ENUMERATED {pusch-RepTypeA,pusch-RepTypeB} |

OPTIONAL, -- Need M

| | |
|---|---|
| frequencyHoppingPUSCH-RepTypeB-r16 | ENUMERATED {interRepetition, interSlot} |

OPTIONAL, -- Cond RepTypeB

| | |
|---|---|
| timeReferenceSFN-r16 | ENUMERATED {sfn512} |

```
OPTIONAL -- Need S
    ]]
  }
```

frequencyHopping
The value intraSlot enables ‘Intra-slot frequency hopping’ and the value interSlot enables ‘Inter-slot
frequency hopping’. If the field is absent, frequency hopping is not configured. The field
frequencyHopping applies to configured grant for ‘pusch-RepTypeA’ (see TS 38.214 [19], clause 6.3.1).
frequencyHoppingOffset
Frequency hopping offset used when frequency hopping is enabled (see TS 38.214 [19], clause 6.1.2
and clause 6.3).
frequencyHoppingPUSCH-RepTypeB
Indicates the frequency hopping scheme for Type 1 CG when pusch-RepTypeIndicator is set to ‘pusch-
RepTypeB’ (see TS 38.214 [19], clause 6.1). The value interRepetition enables ‘Inter-repetition
frequency hopping’, and the value interSlot enables ‘Inter-slot frequency hopping’. If the field is absent,
the frequency hopping is not enabled for Type 1 CG.

### PUCCH-Config Information Element

| | |
|---|---|
| PUCCH-FormatConfig ::= | SEQUENCE { |
| interslotFrequencyHopping | ENUMERATED {enabled} |

OPTIONAL, -- Need R

| | |
|---|---|
| additionalDMRS | ENUMERATED {true} |

OPTIONAL, -- Need R

| | |
|---|---|
| maxCodeRate | PUCCH-MaxCodeRate |

OPTIONAL, -- Need R

| | |
|---|---|
| nrofSlots | ENUMERATED {n2,n4,n8} |

OPTIONAL, -- Need S

| | |
|---|---|
| pi2BPSK | ENUMERATED {enabled} |

OPTIONAL, -- Need R

| | |
|---|---|
| simultaneousHARQ-ACK-CSI | ENUMERATED {true} |

OPTIONAL -- Need R
}

| | |
|---|---|
| PUCCH-Resource ::= | SEQUENCE { |
| pucch-ResourceId | PUCCH-ResourceId, |
| startingPRB | PRB-Id, |
| intraSlotFrequencyHopping | ENUMERATED { enabled } |

OPTIONAL, -- Need R

| | |
|---|---|
| secondHopPRB | PRB-Id |

OPTIONAL, -- Need R

| | |
|---|---|
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |

}
}

PUCCH-FormatConfig field descriptions

interslotFrequencyHopping
If the field is present, the UE enables inter-slot frequency hopping when PUCCH Format 1, 3 or 4 is
repeated over multiple slots. For long PUCCH over multiple slots, the intra and inter slot frequency
hopping cannot be enabled at the same time for a UE. The field is not applicable for format 2. See TS
38.213 [13], clause 9.2.6.

PUCCH-Resource, PUCCH-ResourceExt field descriptions

intraSlotFrequencyHopping
Enabling intra-slot frequency hopping, applicable for all types of PUCCH formats. For long PUCCH over
multiple slots, the intra and inter slot frequency hopping cannot be enabled at the same time for a UE. See
TS 38.213 [13], clause 9.2.1.

With respect to frequency hopping signaling, related contents from 3GPP TS 38.212 v16.1.0 are as follows.

### In Format 0_0,

Frequency domain resource assignment—┌log₂(N_{RB}^{ULBWP} (N_{RB}^{ULBWP}+1)/2┐ bits if neither of the higher layer parameters useInterlacePUSCH-Common and userInterlacePUSCH-Dedicated is configured, where N_{RB}^{ULBWP} is defined in clause 7.3.1.0
   For PUSCH hopping with resource allocation type 1:
      N_{UL_hop} MSB bits are used to indicate the frequency offset according to Clause 6.3 of [6, TS 38.214], where N_{UL_hop}=1 if the higher layer parameter frequencyHoppingOffsetLists contains two offset values and N_{UL_hop}=2 if the higher layer parameter frequencyHoppingOffsetLists contains four offset values
      ┌log₂(N_{RB}^{ULBWP} (N_{RB}^{ULBWP}+1)/2┐−N_{UL_hop} bits provides the frequency domain resource allocation according to Clause 6.1.2.2.2 of [6, TS 38.214]
Frequency hopping flag—1 bit according to Table 7.3.1.1.1-3, as defined in Clause 6.3 of [6, TS 38.214]

### In Format 0_1 and Format 0_2

Frequency domain resource assignment—number of bits determined by the following, where N_{RB}^{UL,BWP} is the size of the active UL bandwidth part:
   If higher layer parameter useInterlacePUSCH-Dedicated-r16 is not configured
      For resource allocation type 1, the ┌log₂(N_{RB}^{ULBWP} (N_{RB}^{ULBWP}+1)/2┐ LSBs provide the resource allocation as follows:
         For PUSCH hopping with resource allocation type 1:
         N_{UL_hop} MSB bits are used to indicate the frequency offset according to Clause 6.3 of [6, TS 38.214], where N_{UL_hop}=1 if the higher layer parameter frequencyHoppingOffsetLists contains two offset values and N_{UL_hop}=2 if the higher layer parameterfrequencyHoppingOffsetLists contains four offset values
         ┌log₂(N_{RB}^{ULBWP} (N_{RB}^{ULBWP}+1)/2┐−N_{UL_hop} bits provides the frequency domain resource allocation according to Clause 6.1.2.2.2 of [6, TS 38.214]
         For non-PUSCH hopping with resource allocation type 1:
         ┌log₂(N_{RB}^{ULBWP} (N_{RB}^{ULBWP}+1)/2┐ bits provides the frequency domain resource allocation according to Clause 6.1.2.2.2 of [6, TS 38.214]
Frequency hopping flag—0 or 1 bit:
   0 bit if only resource allocation type 0 is configured, or if the higher layer parameter frequencyHopping is not configured and the higher layer parameter pusch-RepTypeIndicatorForDCI-Format0-1-r16 is not configured to pusch-RepTypeB, or if the higher layer parameter frequencyHoppingForDCI-Format0-1-r16 is not configured and pusch-RepTypeIndicatorForDCI-Format0-1-r16 is configured to pusch-RepTypeB, or if only resource allocation type 2 is configured;
   1 bit according to Table 7.3.1.1.1-3 otherwise, only applicable to resource allocation type 1, as defined in Clause 6.3 of [6, TS 38.214].

TABLE 7.3.1.1.1-3
Frequency hopping indication

| Bit field mapped to index | PUSCH frequency hopping |
|---|---|
| 0 | Disabled |
| 1 | Enabled |

With respect to phase-related UE capabilities, in NR R-16, requirements of phase and power error difference between antenna ports are defined in 3GPP TS 38.101-1 v16.3.0 as below.

### 6.4D.4 Requirements for Coherent UL MIMO

For coherent UL MIMO, Table 6.4D.4-1 lists the maximum allowable difference between the measured relative power and phase errors between different antenna ports in any slot within the specified time window from the last transmitted SRS on the same antenna ports, for the purpose of uplink transmission (codebook or non-codebook usage) and those measured at that last SRS. The requirements in Table 6.4D.4-1 apply when the UL transmission power at each antenna port is larger than 0 dBm for SRS transmission and for the duration of time window.

TABLE 6.4D.4-1
Maximum allowable difference of relative phase and power errors in
a given slot compared to those measured at last SRS transmitted

| Difference of relative | Difference of relative | |
|---|---|---|
| phase error | power error | Time window |
| 40 degrees | 4 dB | 20 msec |

PUSCH when UE is in RRC connected state has been identified as one of the bottlenecks of cell coverage. In NR Rel-15 and Rel-16, PUSCH repetition has been studied and improved, but it still has some restrictions, for example, the maximum and allowed number of repetitions, DMRS configuration and frequency hopping pattern across repetitions.

For UEs in cell edge, the signal noise ratio (SNR) for each single repetition of PUSCH is quite low, meaning that channel estimation error might be big especially when the number of DMRS symbols used for channel estimation is small. Thus, it would be desirable to use cross slot channel estimation to improve the channel estimation accuracy so as to improve the PUSCH receiver performance.

The present disclosure proposes an improved solution for uplink transmission. The solution may be applied to a communication system including a terminal device and a base station. The terminal device can communicate through a radio access communication link with the base station. The base station can provide radio access communication links to terminal devices that are within its communication service cell. Note that the communications may be performed between the terminal device and the base station according to any suitable communication standards and protocols.

The base station may be, for example, a node B (NodeB), an evolved NodeB (eNodeB or eNB), a next generation NodeB (gNodeB or gNB), a remote radio unit (RRU), a radio header (RH), a remote radio head (RRH), a relay, an integrated access backhaul (IAB), a low power node such as a femto, a pico, and so forth. A base station may comprise a central unit (CU) and one or more distributed units (DUs). The CU and DU(s) may co-locate in a same base station.

The terminal device may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

Now, several embodiments will be described to explain the solution. In the first embodiment, cross-slot channel estimation is used as a candidate solution of coverage enhancement of PUSCH. It can be applicable to PUSCH repetition Type A or B, or multiple PUSCHs scheduled in slots. For UL channel estimation, a base station (e.g. a gNB) as the receiver can use a cross-slot channel estimation based on coherent combining of slots when e.g. phase continuity is guaranteed for DMRS across slots by a UE. This coherent combining of slots in joint channel estimation can avoid complexity and/or performance loss in estimating phase corrections needed to combine the estimates from different slots.

In order for the gNB to improve its channel estimation by coherently combining transmissions from the UE, it is preferable that the gNB is aware that the UE will minimize the phase difference between its multiple transmissions. Therefore, the UE may indicate or the specification may specify a capability to control relative phase between transmissions at different time instants.

Note that in some cases, multiple PUSCH transmissions may happen in one slot, such as multiple independently scheduled PUSCHs in a slot or multiple actual repetitions of PUSCH repetition Type B in a slot. The gNB can do joint channel estimation among multiple PUSCHs in a slot. Thus, in the present disclosure, the term “cross-slot channel estimation” is used merely for the purpose of conciseness and it can also cover cross-PUSCH in a slot.

With respect to the mechanisms for coherent transmission over time

Various mechanisms can affect the ability of a UE to maintain constant phase that is beneficial for multi-transmission channel estimation. For example, because power amplifiers are not perfectly linear devices, transmitting signals at different power levels can result in different phases. Uplink frequency error (that is, transmitting at an offset from the uplink carrier frequency) leads to phase rotation over time and therefore also produces different phases in different slots or symbols.

Furthermore, since uplink transmission in NR can occur on different antenna ports, it is important to take them into account when characterizing the variation. An antenna port is defined such that the radio channel conditions over which a symbol on the antenna port is conveyed can be inferred. Different antenna ports can travel through different radio channel conditions, and so these will often have different phase and/or gain. Requiring the UE to compensate for the different gain or phase may be possible in some cases, but is at least difficult and in general contrary to the design of NR. Therefore, some embodiments herein simplify the implementation by requiring the UE to maintain relative phase over a given antenna port.

As mentioned above, there are relative phase requirements for UL multiple input multiple output (MIMO) operation that must be maintained over a period of time. These phase requirements are between antenna ports, and so are quite different than for maintaining the phase of a same antenna port over time. For example, relative phase of transmit chains using the same local oscillator will generally not have frequency differences between the ports, unlike the case of carrier frequency offset discussed above.

Varying multi-antenna transmission can also affect the relative phase of transmissions. Applying a different uplink precoder, transmitting on a different antenna, beam or transmit chain can all lead to different phases if they vary between different transmissions.

In many cases, a more complex UE implementation could allow phase to be constant, or at least vary less, across transmissions that would otherwise vary due to the mechanisms above. However, reducing UE complexity and improving the feasibility of more phase constant transmissions can be desirable to facilitate the market for such UEs. Therefore, some embodiments that facilitate maintaining phase across transmissions in UEs are considered.

A first constraint is to schedule the UE with a same transmission power in the first and second transmissions. This can be accomplished by scheduling the UE with a single power value for all repetitions, by indicating a 0 dB power control command for a second transmission relative to the first transmission, and/or by constraining open loop power control to use the same value for different transmissions.

Constraining multi-antenna transmission to facilitate reduced phase variation across transmissions can include limiting the UE to use a single uplink precoder by indicating a single transmitted precoding matrix indicator (TPMI) to be used for the first and the second transmission.

While the average power the UE transmits with in a scheduling unit of time is important, it is not the only relevant parameter. When the UE transmits a cyclic prefix orthogonal frequency division multiplexing (CP-OFDM) signal, if the number of subcarriers varies, the peak to average power of the signal can vary. Therefore, it can be beneficial to transmit on a same number of subcarriers in different transmissions to make it more likely that the same amount of power amplifier (PA) backoff is needed across transmissions, and so that the same average power can be used, which in turn may make it easier to maintain constant phase across different transmissions.

Another consideration is that analog filters in the UE's transmit (Tx) chains will have ripple, and so scheduling in different sets of subcarriers in different transmissions can lead to phase and/or gain differences between the transmissions. Therefore, another constraint that may facilitate reduced phase variation across transmissions is to transmit in the same subcarriers in the different transmissions.

Each physical channel or signal (for example PUSCH, physical uplink control channel (PUCCH), PRACH, sounding reference signal (SRS), etc.) often has its own power control loop and power control settings. Therefore, transmitting a different set of physical channels in two different time instances will lead to different power values. Different channels could potentially have different timing advance which would also cause phase differences among transmissions. Therefore, another constraint can be that the same content (that is, the same set of physical channels or signals) is carried in the different transmissions. For example, if a PUSCH and its DMRS are transmitted in a first transmission, the same PUSCH and DMRS should be transmitted in the second transmission according to this constraint.

As discussed above, the mechanisms such as carrier frequency offset can lead to different phases across time. The greater the time difference between the transmissions, the greater the phase offset will be for a given amount of frequency offset. Furthermore, if there is a gap between two UE transmissions that allows a downlink transmission in time division duplex (TDD), the UE may turn off a power amplifier to save power during the downlink slot, but then would need to turn it back on again for the second transmission. This on-off-on switching may cause some variation in power between the transmissions. Considering these effects, still another constraint can be that the two UL transmissions must be contiguous in time, such that the second transmission immediately follows the first.

UEs that transmit on multiple carriers may do so on a single transmit chain, for example in intra-band carrier aggregation. This means that the carriers share the power available in a PA on the transmit chain, and transmitting on one carrier can mean that less power is available for the other carrier. Therefore, to maintain constant power and to facilitate maintaining the same phase, the same carriers should be scheduled and in the same way on the different transmissions.

Maintaining coherence across slots is not always needed since it may require the UE to expend extra power or computational or other complexity to do so. Therefore, dynamically indicating when cross slot coherence is required may be beneficial for the UE. Another constraint can therefore be that the gNB indicate particular time instants (slots, symbols, or radio frames) over which the UE should maintain phase coherence.

### With Respect to the Cross-Slot Channel Estimation Capability for UE

UE may have different capabilities of keeping continuity phase across slots, especially non-contiguous slots. Besides time, another factor impacting phase is UE's transmission power. Some UE have a multi-stage PA. Therefore, for such UE, UL transmission phase may change when UL transmission power leads to a switch among multiple stages of the PA. Frequency offset from central frequency of the BWP and UL spatial relation also impact phase continuity across slots.

As the second embodiment, UE capabilities regarding the support of cross-slot channel estimation (e.g. phase continuity) can be related to one or more of the following factors on different PUSCH transmissions:
same or different allocated frequency resource and/or frequency hop;
same or different UE transmit power;
same or different UL TX beam/spatial transmission filter.

Some examples can be provided as follows.
With the same allocated PRB, UL transmission power and UL spatial relation
   UE is able to keep phase continuity across X consecutive slots (X=1, 2, 3, 4 . . . ). For such UE, UE can also indicate X to gNB. X=1 means UE's capability of keeping phase continuity across multiple PUSCHs in one slot.
   UE is able to keep phase continuity across at most X consecutive slots, but unable to keep between non-contiguous slots.
   UE is able to keep phase continuity across slots whether they are contiguous or not.
With different UL transmission power, the same allocated PRB and spatial relation
   UE is unable to keep phase continuity if UL transmission power changes.
   UE is able to keep phase continuity, if the UL transmission power change is within a range so that there is no switch of PA stage. UE can also indicate the maximum power change in order to keep phase continuity.
      For example, UE indicates 3 dB, which means if its transmission power difference is no more than 3 dB, the same phase can remain.
   UE is able to keep phase continuity, if the UL transmission powers used on different slots are within one interval among a set of power value intervals defined from the minimum TX power and the maximum TX power allowed.
      For example, 4 intervals of UE TX power values are defined as [11 dBm, 14 dBm], [14 dBm, 17 dBm], [17 dBm, 20 dBm], [20 dBm, 23 dBm], and if its transmission (TX) powers for the slots are within one interval, the same phase can remain.
   UE is able to keep phase continuity regardless of transmission power difference.
With the same transmission power and UL spatial relation, UE's phase rotation in terms of the frequency difference between central frequencies of the BWP and allocated PUSCH PRB also needs to be reported.
   For example, the ratio between UE's phase rotation and frequency difference (or just an upper limit on the frequency difference below which the UE is capable to maintain a certain small phase rotation, and above which the UE is not capable of this).
With same spatial transmission filter across multiple slots is required to maintain coherency across slots. This is especially needed for non-codebook based PUSCH transmission where UE determines UL precoder.
   Note that a UE could be optionally required to ignore transmit power changes between slots that are part of a repetition.

In an sub-embodiment of the second embodiment, slots considered for cross-slot channel estimation can be PUSCH transmissions that are:
Repetitions scheduled with dynamic grant;
Repetitions scheduled by configured grant;
separately scheduled PUSCHs from one UE in multiple.

In another sub-embodiment of the second embodiment, coherency across slots can be limited to slots using the same hopping frequency (same PRB allocation). This can either be slots sharing a joint indicator of frequency, or slots that use the same frequency even though they possibly have separate indicator of their respective frequencies.

In one example for this sub-embodiment, UE promises cross-slot coherency capability between slots on the allocated bandwidth, where the same PRB are occupied across slots and no UE capability is defined for this case (same PRB allocation across PUSCH repetitions).

As the third embodiment, cross-slot coherency capabilities of a UE can be defined with one or more of the following aspects:
define one or multiple level of capabilities;
for each capability level, define the number of time instants (e.g. the number of slots) that can be thought of as coherent (can do cross slot channel estimation, one channel cross multiple slots);
Consider one or more of the following parameters:
   different numerologies, e.g. with higher SCS, more slots can be required (since it is shorter)
   whether it is only front-loaded DMRS or not, e.g. with more DMRS configured per slot, less number of slots can be required (since channel estimation per slot is enough);
   Number of repetitions;
   UE speed, e.g. for low speed scenarios, a large number of slots can be required since the channel is not changing that fast;
   Duration of a PUSCH transmission, e.g. the number of OFDM symbols allocated for each PUSCH repetition.

As an example, two different cross-slot coherency capabilities can be defined. For each capability, the required number of coherent slots can be defined in the two tables below for different subcarrier spacing and different number of DMRS symbols.

TABLE 1
number of coherent slots for cross-slot coherency capability 1

| | number of coherent slots S₁ [slots] | |
|---|---|---|
| μ | dmrs-AdditionalPosition = pos0 | dmrs-AdditionalPosition ≠ pos0 |
| 0 | 2 | 1 |
| 1 | 4 | 2 |
| 2 | 6 | 4 |
| 3 | 8 | 6 |

TABLE 2
number of coherent slots for cross-slot coherency capability 2

| | number of coherent slots S₁ [slots] | |
|---|---|---|
| μ | dmrs-AdditionalPosition = pos0 | dmrs-AdditionalPosition ≠ pos0 |
| 0 | 4 | 2 |
| 1 | 6 | 4 |
| 2 | 8 | 6 |
| 3 | 10 | 8 |

As the fourth embodiment, UE can be indicated whether to keep cross-slot coherency or in which time instants (e.g. slots, sub-slots)/repetitions or for some number of contiguous slots/repetitions it needs to keep phase continuity.

As the fifth embodiment, UE may report its capability and/or capability level of supporting channel estimation (at the receiver) across slots to a gNB with respect to one or more of the factors mentioned in the second embodiment and the third embodiment.

### With Respect to Frequency Hopping Pattern Determination for Repetitions

As the sixth embodiment, the frequency hopping pattern for different UEs can be indicated cell specifically via system information block (SIB) or UE specifically via RRC or L1 signaling in DCI. With this embodiment, interference can be randomized and it can be more robust to interference.

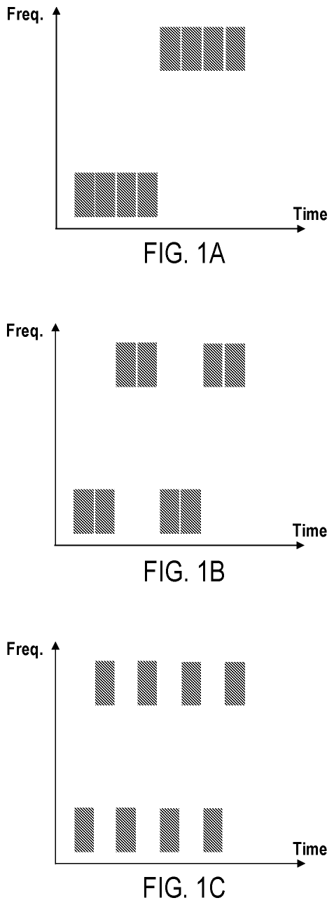

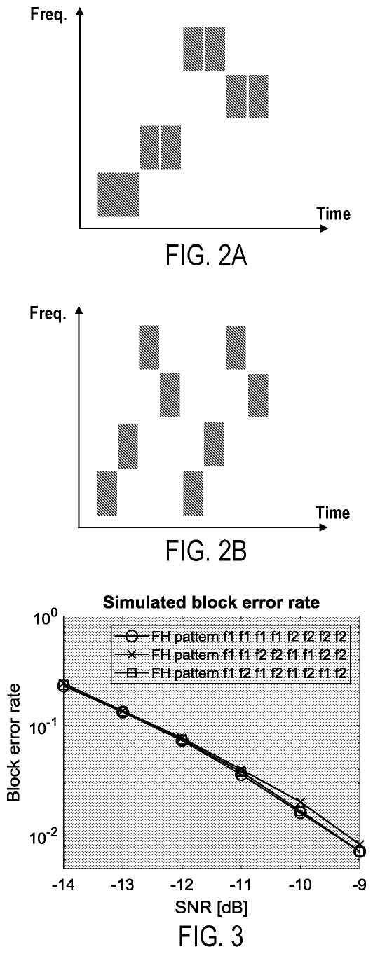

A few examples of (Hadamard-sequence-like) frequency hopping patterns are illustrated in FIGS. 1A-1C (corresponding to the case of 8 repetitions and 2 different hopping frequencies) and FIGS. 2A-2B (corresponding to the case of 8 repetitions and 4 different hopping frequencies).

FIG. 3 illustrates the simulated performance for the three hopping patterns of FIGS. 1A-1C. As shown, at low speed, cross-slot/repetition channel estimation among slots (hops/repetitions) using same frequency works similarly well for all these patterns. Hence different UEs could use different patterns to mitigate interference without leading to reduced sensitivity (coverage) performance.

For message 3 (Msg3) PUSCH transmissions during random access procedure, the hopping pattern would have to be configured via SIB and/or Msg2 random access response (RAR) (or be the same in all systems). This poses the following specific problems. Firstly, SIB is common to all users in a cell, and hence cannot be used to signal different patterns to different UEs (which would be desirable in order to mitigate interference). Secondly, Msg2 RAR is rather small and cannot reasonably describe a hopping pattern to the UE.

As the seventh embodiment, one or more of the following options can be used for frequency hopping pattern determination for Msg3 PUSCH. As the first option, the Msg2 RAR is extended with only a few bits, which function as an index into a table of hopping patterns. The table could either be predefined in the technical specifications, or it could be signaled in SIB. Alternatively, the SIB could contain a field that selects one among several predefined tables in the specifications, into which the RAR bits then index.

As the second option, the Msg2 RAR could contain a few bits that serve as an input to a function that is used to derive the hopping pattern. This function could e.g. be a pseudo-random number generator where the input is the random-number generator seed.

As the third option, the hopping pattern could be determined based on the PRACH transmission, e.g. which preamble was used and/or which PRACH occasion was used. If hopping is a UE capability, partitioning of PRACH preambles could be designed so that UE supporting hopping selects a certain group of preambles.

As the fourth option, the cell ID could be used to determine the hopping pattern. Alone, this would mitigate only inter-cell interference. But if combined with any of the above options, it could mitigate also intra-cell interference.

### With Respect to DMRS Configuration of PUSCH Repetitions in Multiple Slots

In NR Rel-15 and Rel-16, one DMRS configuration is applied for all PUSCH repetitions of a transport block (TB) from the UE. Cross-slot channel estimation implies that DMRS in one slot/repetition can aid channel estimation in adjacent slots/repetitions. If gNB predicts radio channel is static and suitable for cross-slot channel estimation, it can let UE reduce or omit DMRS symbols in the PUSCH in some slots. Note that zero DMRS in a PUSCH in a slot can also be regarded as a DMRS configuration in the present disclosure.

PUSCH with less or no DMRS can be used for PUSCH repetition Type A or Type B, with dynamic or configured grant. In such cases, DMRS configuration, including the number and locations of DMRS symbols, in each repetition/slot needs to be configured.

As the eighth embodiment, UE can be configured in RRC or DCI signaling with the DMRS pattern across slots/repetitions. For example, a DMRS pattern configuration may comprise the number and locations of DMRS symbols in each repetition/slot.

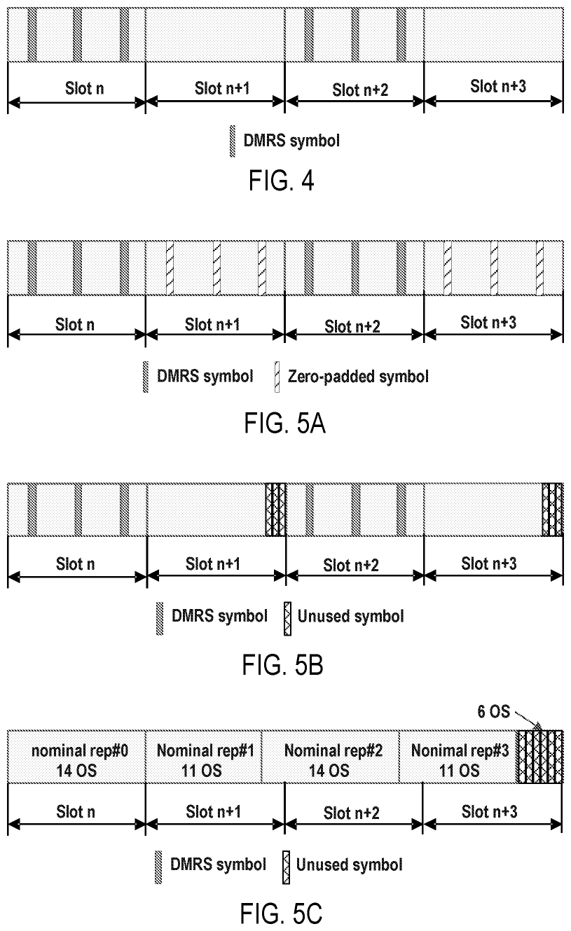

For PUSCH repetition Type A, which is slot-based, either bitmap of repetitions or bitmap of slots can be configured. For example, a 4-bit bitmap with value 1010 means the first and the third slots will have a default DMRS configuration and the other two slots will use a special DMRS configuration with less or no DMRS symbols in a slot, as shown in FIG. 4. For PUSCH repetition Type B, bitmap of repetition can be applicable.

As the ninth embodiment, if multiple DMRS configurations are configured across slots/repetitions, UE can transmit in one or more of the following ways. Note that the length of PUSCH here means the total number of contiguous symbols for data and DMRS transmissions in a PUSCH. As the first option, UE keeps the same length of PUSCH for different DMRS configurations, by different TBS determinations for different DMRS configurations, or same TBS determination and separate adaptations (e.g. rate matching or zero/dummy bits padding or puncture) for different DMRS configurations. For example, as illustrated in FIG. 5A, UE is scheduled with PUSCH repetitions in 4 slots. The symbol index of the start symbol is S=0, the length of PUSCH is L=14 OFDM symbols, the number of repetitions is K=4. The numbers of UL DMRS symbols are configured to be “3, 0, 3, 0” for the 4 consecutive slots/repetitions. Thus, the UE transmits PUSCH in slot n and n+2 as in Rel-15. In slot n+1 and n+3, the UE transmits PUSCH data in 11 symbols, and adds zero in the omitted DMRS symbols in order to extend to 14 symbols.

As the second option, UE keeps different lengths of PUSCH for different DMRS configurations and UE determines TBS once for all repetitions (i.e. the same TBS determination is used). For example, as option 2a, for PUSCH repetition Type A, the UE leaves the omitted DMRS symbols at the end of each slot. As option 2b, for PUSCH repetition Type B, the repetitions can be contiguous without gap.

In an example with the same configuration as FIG. 5A, the symbol index of the start symbol is S=0, the length of PUSCH is L=14 OFDM symbols, the number of repetitions is K=4. The numbers of UL DMRS symbols are configured to be “3, 0, 3, 0” for the 4 consecutive slots/repetitions. With the second option, the UE does TBS calculation based on 11 data symbols and resource element (RE) matching to 11 data symbols in a slot. FIG. 5B shows the option 2a for PUSCH repetition Type A. As shown, in slot n+1 and n+3, the UE leaves the omitted DMRS symbols together at the end of a slot, and there is only one repetition in a slot. FIG. 5C shows the option 2b for PUSCH repetition Type B, and “3 0 3 0” are the number of DMRS symbols in these repetitions, not slots. Nominal repetitions #1 and #3 have 11 OFDM symbols without DMRS symbols, and there is no gap between consecutive nominal repetitions.

As the third option, UE keeps different lengths of PUSCH for different DMRS configurations and UE determines different TBS once for all repetitions. For example, this option may be used when 3 different number of DMRS symbols are configured for different slots.

Based on the above description, one aspect of the present disclosure provides a method in a UE of coherent transmission over time. The method may comprise indicating to a network that the UE is capable to transmit in at least a first and a second time instant on a same antenna port with a limited difference in phase. The method may further comprise transmitting a same content in the first time instant on the same antenna port in a first set of subcarriers. The same content may be at least one of a physical channel and a physical signal. The method may further comprise transmitting the same content in the second time instant on the same antenna port in a second set of subcarriers such that a phase difference between each of the subcarriers in the second set and each of the subcarriers in the first set is no more than a predetermined phase difference.

In the above aspect, the UE indicates capability for relative phase on an antenna port. The UE transmits the same physical channels or signals at different times on the antenna port, maintaining a single relative phase between the transmissions. Note that it is also possible for the technical specification to specify the capability requirement that the UE is or should be capable to transmit in at least a first and a second time instant on a same antenna port with a limited difference in phase.

In an embodiment, the number of subcarriers in the first and the second set of subcarriers is the same. That is, transmissions have the same number of subcarriers.

In an embodiment, the first and second sets of subcarriers are the same. That is, the transmissions are performed in the same subcarriers.

In an embodiment, the first and second time instants comprise a first and a second slot, or comprise a first and a second sub-slot, or comprise a first and a second multiple-slot. That is, the first and second time instants are measured as slots, sub-slots, multiple-slots.

In an embodiment, the second time instant immediately follows the first time instant. That is, the time instants are contiguous.

In an embodiment, when the UE is scheduled on a plurality of carriers, the UE transmits in the first and the second slot with the same or neighboring carriers/carrier groups. Thus, the same number of carriers may be scheduled.

In an embodiment, the method may further comprise receiving signaling to transmit in the first and the second time instant with at least one of a same power level and a same precoder. That is, one of the power and precoding is the same.

In an embodiment, the method may further comprise receiving signaling identifying the first and second time instant out of a plurality of time instants. That is, the UE is indicated which particular instants in time it should transmit coherently over.

In an embodiment, the method may further comprise transmitting in a third set of subcarriers distinct from the first and second set of subcarriers. The constraint on the relative phase between the third set of subcarriers and the first or the second set of subcarriers is greater than the predetermined phase difference. That is, the UE uses frequency hopping and the coherency is only for adjacent slots with same subcarriers.

In an embodiment, the UE indicates its capability for operation for when the first and second transmission are separated by no more than a predetermined length of time. That is, the UE indicates a period of time over which coherence can be maintained.

In an embodiment, the UE indicates its capability for operation for when the first and second transmission are transmitted with a power difference that is no more than a predetermined value. That is, the UE indicates a power difference over which coherence can be maintained.

In an embodiment, the UE indicates its capability for operation for when the first and second set of subcarriers are separated by a frequency difference that is no more than a predetermined value. That is, the UE indicates a frequency difference over which coherence can be maintained.

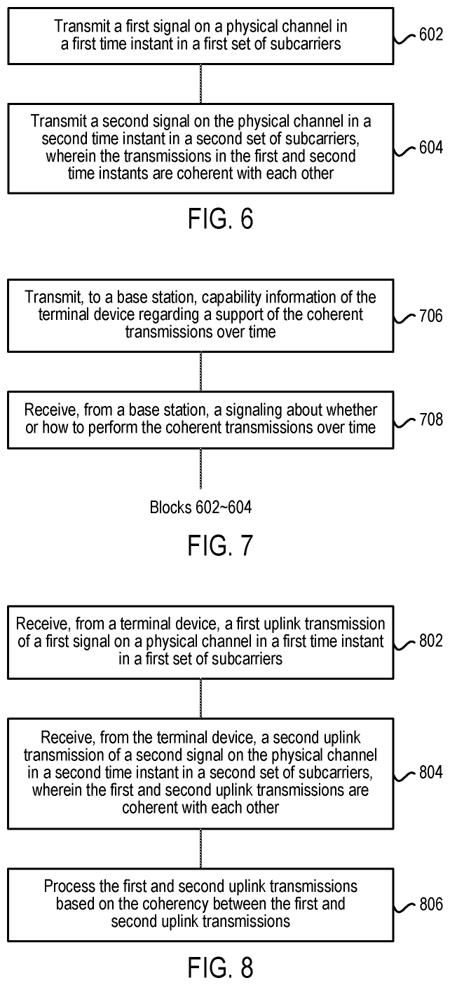

Hereinafter, the solution of the present disclosure will be further described with reference to FIGS. 6-27. FIG. 6 is a flowchart illustrating a method performed by a terminal device according to an embodiment of the disclosure. At block 602, the terminal device transmits a first signal on a physical channel in a first time instant in a first set of subcarriers. For example, the physical channel may be a PUSCH. The first signal may be at least one of a payload of the PUSCH and DMRS symbols. The first time instant may be a slot or a sub-slot.

At block 604, the terminal device transmits a second signal on the physical channel in a second time instant in a second set of subcarriers. For example, the second signal may be at least one of a payload of the PUSCH and DMRS symbols. As an exemplary example, the second signal may be a repetition of the first transmitted signal. The second time instant may be a slot or a sub-slot. The transmission in the first time instant and the transmission in the second time instant may be scheduled with a dynamic grant, or with a configured grant, or separately with independent grants. The transmission in the first time instant and the transmission in the second time instant are coherent with each other. For example, the two transmissions may be coherent with each other in terms of at least one of phase, transmission power and beam. With respect to the coherency in phase, a difference in phase and/or a difference in phase error and/or an error of phase difference between each of the subcarriers in the second set and each of the subcarriers in the first set may be smaller than or equal to a predetermined threshold. With the method of FIG. 6, it is possible for a base station to improve the reception performance of the physical channel by utilizing the coherency between the transmissions.

To keep the coherency between the two transmissions, any one or any combination of the following options may be used. As a first option, the transmission in the first time instant and the transmission in the second time instant may be performed on a same antenna port. As a second option, the transmission in the first time instant and the transmission in the second time instant may be performed with at least one of: a same transmission power; a same spatial transmission filter; and a same uplink precoder. As a third option, the number of the first set of subcarriers may be the same as the number of the second set of subcarriers. As a fourth option, the first set of subcarriers may be the same as the second set of subcarriers. As a fifth option, in a case where the terminal device is scheduled on a plurality of carriers (e.g. in carrier aggregation scenario), the first set of subcarriers and the second set of subcarriers may belong to a same carrier/carrier group or neighboring carriers/carrier groups. As a sixth option, the second time instant may immediately follow the first time instant.

FIG. 7 is a flowchart illustrating a method performed by a terminal device according to another embodiment of the disclosure. As shown, the method comprises blocks 706-708 and blocks 602-604 described above. At block 706, the terminal device transmits, to a base station, capability information of the terminal device regarding a support of the coherent transmissions over time. For example, the capability information may be transmitted in response to an enquiry from the base station during an initial registration process (e.g. an attach procedure). The capability information may indicates at least one of: the number of time instants over which the terminal device is capable of supporting the coherent transmissions over time; and a condition under which the terminal device is capable of supporting the coherent transmissions over time. The condition may be related to one or more of following factors: allocated frequency resource; hopping frequency; transmission power; uplink transmission beam or spatial transmission filter; phase rotation; subcarrier spacing; demodulation reference signal (DMRS) configuration; a number of repetitions of the first transmitted signal; a speed of the terminal device; and the like.

At block 708, the terminal device receives, from the base station, a signaling about whether or how to perform the coherent transmissions over time. The transmission in the first time instant and the transmission in the second time instant may be performed based on the received signaling. For example, the received signaling may indicate one or more of: whether to perform the coherent transmissions over time; in which time instants the coherent transmissions over time are to be performed; a number of contiguous time instants in which the coherent transmissions over time are to be performed; and at least one parameter with which the coherent transmissions over time are to be performed. For example, any one or any combination of the options described above for keeping the coherency may be indicated as the at least one parameter.

Since the option(s) taken by the terminal device for keeping the coherency is possible to be predefined between the terminal device and the base station, block 708 may be an optional block. Thus, one embodiment of the disclosure provides a method comprising blocks 706, 602 and 604. Since it is also possible that terminal devices within the serving cell of a base station all support the coherent transmissions over time, block 706 may be an optional block. Thus, one embodiment of the disclosure provides a method comprising blocks 708, 602 and 604. Specifically, at block 708, the terminal device receives, from a base station, a signaling about whether and/or how to perform coherent transmissions over time. At block 602, the terminal device transmits, based on the received signaling, a first signal on a physical channel in a first time instant in a first set of subcarriers. At block 604, the terminal device transmits, based on the received signaling, a second signal on the physical channel in a second time instant in a second set of subcarriers. The transmission in the first time instant and the transmission in the second time instant are coherent with each other.

FIG. 8 is a flowchart illustrating a method performed by a base station according to an embodiment of the disclosure. At block 802, the base station receives, from a terminal device, a first uplink transmission of a first signal on a physical channel in a first time instant in a first set of subcarriers. For example, the physical channel may be a PUSCH. The first signal may be at least one of a payload of the PUSCH and DMRS symbols. The first time instant may be a slot or a sub-slot.

At block 804, the base station receives, from the terminal device, a second uplink transmission of a second signal on the physical channel in a second time instant in a second set of subcarriers. For example, the second signal may be at least one of a payload of the PUSCH and DMRS symbols. As an exemplary example, the second signal may be a repetition of the first transmitted signal. The second time instant may be a slot or a sub-slot. The first uplink transmission and the second uplink transmissions may be scheduled with a dynamic grant, or with a configured grant, or separately with independent grants. The first uplink transmission and the second uplink transmission are coherent with each other. For example, the two transmissions may be coherent with each other in terms of at least one of phase, transmission power and beam. With respect to the coherency in phase, a difference in phase and/or a difference in phase error and/or an error of phase difference between each of the subcarriers in the second set and each of the subcarriers in the first set may be smaller than or equal to a predetermined threshold.

Since there is coherency between the two uplink transmissions, blocks 802 and 804 may be performed with any one or any combination of the following options. As a first option, the first uplink transmission and the second uplink transmissions may be performed on a same antenna port. As a second option, the first uplink transmission and the second uplink transmissions may be performed with at least one of: a same transmission power; a same spatial transmission filter; and a same uplink precoder. As a third option, the number of the first set of subcarriers may be the same as the number of the second set of subcarriers. As a fourth option, the first set of subcarriers may be the same as the second set of subcarriers. As a fifth option, in a case where the terminal device is scheduled on a plurality of carriers (e.g. in carrier aggregation scenario), the first set of subcarriers and the second set of subcarriers may belong to a same carrier/carrier group or neighboring carriers/carrier groups. As a sixth option, the second time instant may immediately follow the first time instant.

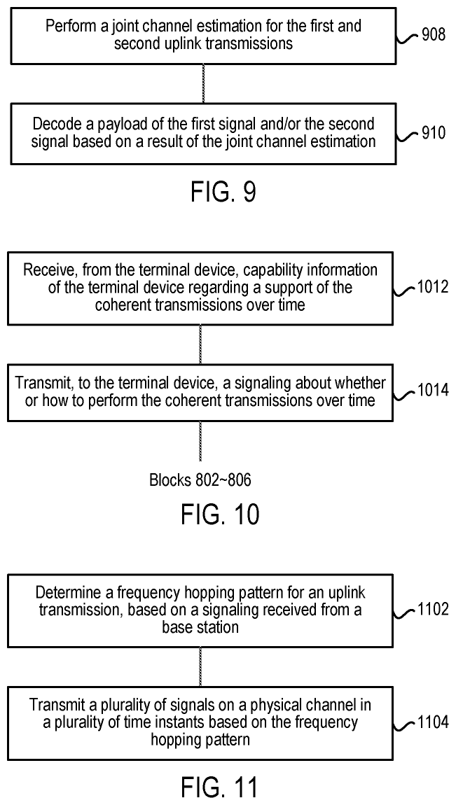

At block 806, the base station processes the first and second uplink transmissions based on the coherency between the first and second uplink transmissions. For example, block 806 may comprise blocks 908 and 910 of FIG. 9. At block 908, the base station performs a joint channel estimation for the first and second uplink transmissions. At block 910, the base station decodes a payload of the first signal and/or the second signal based on a result of the joint channel estimation. With the method of FIG. 8, it is possible for the base station to improve the reception performance of the physical channel by utilizing the coherency between the transmissions.

FIG. 10 is a flowchart illustrating a method performed by a base station according to another embodiment of the disclosure. As shown, the method comprises blocks 1012-1014 and blocks 802-806 described above. At block 1012, the base station receives, from the terminal device, capability information of the terminal device regarding a support of the coherent transmissions over time. The capability information has been described above and its details are omitted here. At block 1014, the base station transmits, to the terminal device, a signaling about whether or how to perform the coherent transmissions over time. The first uplink transmission and the second uplink transmission may be received based on the transmitted signaling. The signaling has been described above and its details are omitted here.

Similar to the embodiment of FIG. 8, since the option(s) taken by the terminal device for keeping the coherency is possible to be predefined between the terminal device and the base station, block 1014 may be an optional block. Thus, one embodiment of the disclosure provides a method comprising blocks 1012 and 802-806. Since it is also possible that terminal devices within the serving cell of a base station all support the coherent transmissions over time, block 1012 may be an optional block. Thus, one embodiment of the disclosure provides a method comprising blocks 1014 and 802-806. Specifically, at block 1014, the base station transmits, to a terminal device, a signaling about whether and/or how to perform coherent transmissions over time. At block 802, the base station receives, from the terminal device, a first uplink transmission of a first signal on a physical channel in a first time instant in a first set of subcarriers, based on the transmitted signaling. At block 804, the base station receives, from the terminal device, a second uplink transmission of a second signal on the physical channel in a second time instant in a second set of subcarriers, based on the transmitted signaling. The first uplink transmission and the second uplink transmission are coherent with each other. At block 806, the base station process the first and second uplink transmissions based on the coherency between the first and second uplink transmissions.

FIG. 11 is a flowchart illustrating a method performed by a terminal device according to an embodiment of the disclosure. At block 1102, the terminal device determines a frequency hopping pattern for an uplink transmission, based on a signaling received from a base station. For example, the signaling may be a cell specific signaling or a signaling dedicated for the terminal device. As a first option, the signaling may be a random access response that is extended with a first parameter indicating an index by which the frequency hopping pattern can be determined from a predetermined table. The predetermined table may indicate correspondences between multiple predetermined frequency hopping patterns and multiple predetermined indexes. As a second option, the signaling may be a random access response that is extended with a second parameter serving as an input to a predetermined function for determining the frequency hopping pattern. As a third option, the signaling may indicate a PRACH configuration for random access. The frequency hopping pattern may be determined based on the PRACH configuration. As a fourth option, the signaling may indicates an ID of a cell serving the terminal device. The frequency hopping pattern may be determined based on the ID of the cell.

At block 1104, the terminal device transmits a plurality of signals on a physical channel in a plurality of time instants based on the frequency hopping pattern. For example, the physical channel may be a PUSCH. Each of the plurality of signals may be at least one of a payload of the PUSCH and DMRS symbols. Each of the plurality of time instants may be a slot or a sub-slot. As an exemplary example, the plurality of signals may be repetitions of each other. With the method of FIG. 11, it is possible to be more robust to interference due to the use of the frequency hopping pattern.

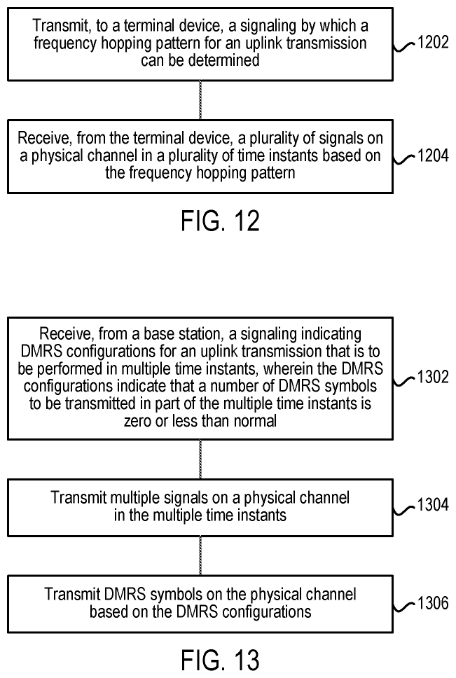

FIG. 12 is a flowchart illustrating a method performed by a base station according to an embodiment of the disclosure. At block 1202, the base station transmits, to a terminal device, a signaling by which a frequency hopping pattern for an uplink transmission can be determined. The signaling has been described above and its details are omitted here. For example, the frequency hopping patterns signaled to different terminal devices may be different to randomize the interference. At block 1204, the base station receives, from the terminal device, a plurality of signals on a physical channel in a plurality of time instants based on the frequency hopping pattern. Block 1204 corresponds to block 1104 and its details are omitted here.

FIG. 13 is a flowchart illustrating a method performed by a terminal device according to an embodiment of the disclosure. At block 1302, the terminal device receives, from abase station, a signaling indicating DMRS configurations for an uplink transmission that is to be performed in multiple time instants. The DMRS configurations indicate that a number of DMRS symbols to be transmitted in part of the multiple time instants is zero or less than normal. For example, the DMRS configurations may be indicated as a bitmap of time instants. The signaling may be an RRC signaling or a DCI signaling.

At block 1304, the terminal device transmits multiple signals on a physical channel in the multiple time instants. For example, the physical channel may be a PUSCH. Each of the multiple signals may comprise a payload of the PUSCH and optionally DMRS symbols. As an exemplary example, the multiple signals may be repetitions of each other. Each of the multiple time instants may be a slot or a sub-slot. At block 1306, the terminal device transmits DMRS symbols on the physical channel based on the DMRS configurations. With the method of FIG. 13, the overhead of DMRS symbols can be reduced due to the use of the DMRS configurations.

As a first option, the transmission of the multiple signals and the transmission of the DMRS symbols may be performed with a same total length of the physical channel for different time instants. For this option, different TBS determinations may be performed for the time instants having different DMRS configurations. Alternatively, a same TBS determination may be performed for the multiple time instants and separate adaptations may be performed for the time instants having different DMRS configurations.

As a second option, the transmission of the multiple signals and the transmission of the DMRS symbols may be performed with different total lengths of the physical channel for the time instants having different DMRS configurations. For this option, a same TBS determination may be performed for the multiple time instants. Alternatively, different TBS determinations may be performed for the time instants having different DMRS configurations.

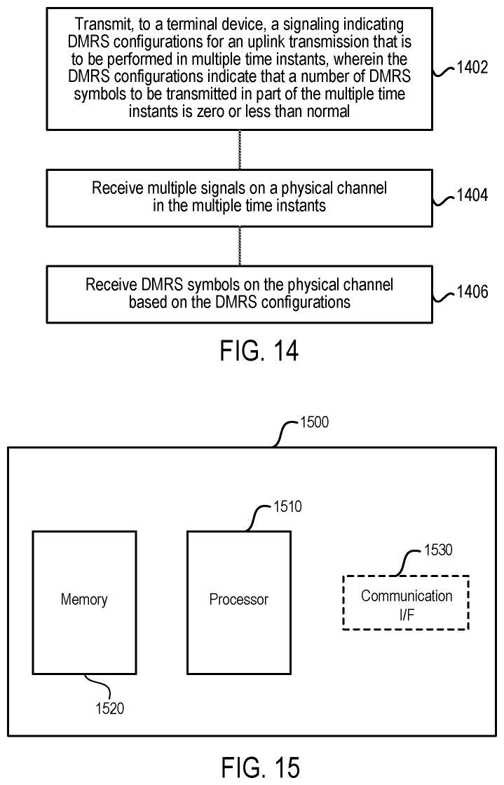

FIG. 14 is a flowchart illustrating a method performed by a base station according to an embodiment of the disclosure. At block 1402, the base station transmits, to a terminal device, a signaling indicating DMRS configurations for an uplink transmission that is to be performed in multiple time instants. The DMRS configurations indicate that a number of DMRS symbols to be transmitted in part of the multiple time instants is zero or less than normal. For example, the DMRS configurations may be indicated as a bitmap of time instants. The signaling may be an RRC signaling or a DCI signaling.

At block 1404, the base station receives multiple signals on a physical channel in the multiple time instants. For example, the physical channel may be a PUSCH. Each of the multiple signals may comprise a payload of the PUSCH and optionally DMRS symbols. As an exemplary example, the multiple signals may be repetitions of each other. Each of the multiple time instants may be a slot or a sub-slot. At block 1406, the base station receives DMRS symbols on the physical channel based on the DMRS configurations. As a first option, the multiple signals and the DMRS symbols may be received with a same total length of the physical channel for different time instants. As a second option, the multiple signals and the DMRS symbols may be received with different total lengths of the physical channel for the time instants having different DMRS configurations. With the method of FIG. 14, the overhead of DMRS symbols can be reduced due to the use of the DMRS configurations.

FIG. 15 is a block diagram showing an apparatus suitable for use in practicing some embodiments of the disclosure. For example, any one of the terminal device and the base station described above may be implemented through the apparatus 1500. As shown, the apparatus 1500 may include a processor 1510, a memory 1520 that stores a program, and optionally a communication interface 1530 for communicating data with other external devices through wired and/or wireless communication.

The program includes program instructions that, when executed by the processor 1510, enable the apparatus 1500 to operate in accordance with the embodiments of the present disclosure, as discussed above. That is, the embodiments of the present disclosure may be implemented at least in part by computer software executable by the processor 1510, or by hardware, or by a combination of software and hardware.

The memory 1520 may be of any type suitable to the local technical environment and may be implemented using any suitable data storage technology, such as semiconductor based memory devices, flash memories, magnetic memory devices and systems, optical memory devices and systems, fixed memories and removable memories. The processor 1510 may be of any type suitable to the local technical environment, and may include one or more of general purpose computers, special purpose computers, microprocessors, digital signal processors (DSPs) and processors based on multi-core processor architectures, as non-limiting examples.

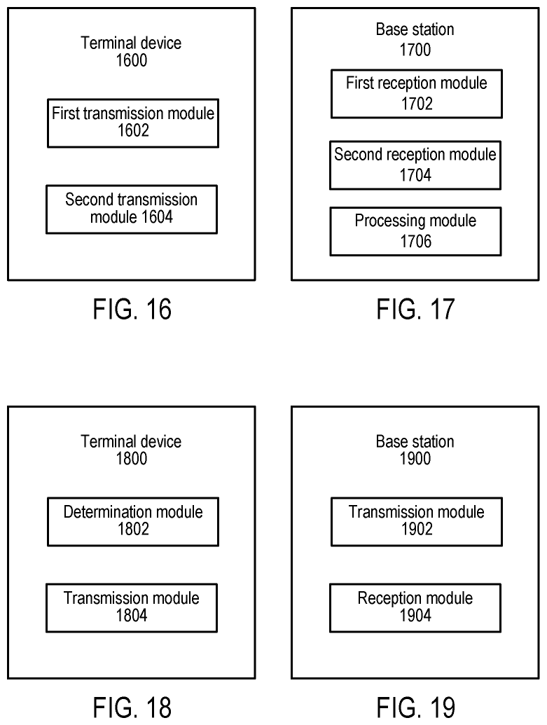

FIG. 16 is a block diagram showing a terminal device according to an embodiment of the disclosure. As shown, the terminal device 1600 comprises a first transmission module 1602 and a second transmission module 1604. The first transmission module 1602 may be configured to transmit a first signal on a physical channel in a first time instant in a first set of subcarriers, as described above with respect to block 602. The second transmission module 1604 may be configured to transmit a second signal on the physical channel in a second time instant in a second set of subcarriers, as described above with respect to block 604. The transmission in the first time instant and the transmission in the second time instant may be coherent with each other.

Optionally, the terminal device 1600 may comprise a reception module configured to receive, from a base station, a signaling about whether and/or how to perform the coherent transmissions over time. The first transmission module 1602 may be configured to transmit the first signal on the physical channel in the first time instant in the first set of subcarriers, based on the received signaling. The second transmission module 1604 may be configured to transmit the second signal on the physical channel in the second time instant in the second set of subcarriers, based on the received signaling.

FIG. 17 is a block diagram showing a base station according to an embodiment of the disclosure. As shown, the base station 1700 comprises a first reception module 1702, a second reception module 1704 and a processing module 1706. The first reception module 1702 may be configured to receive, from a terminal device, a first uplink transmission of a first signal on a physical channel in a first time instant in a first set of subcarriers, as described above with respect to block 802. The second reception module 1704 may be configured to receive, from the terminal device, a second uplink transmission of a second signal on the physical channel in a second time instant in a second set of subcarriers, as described above with respect to block 804. The first uplink transmission and the second uplink transmission may be coherent with each other. The processing module 1706 may be configured to process the first and second uplink transmissions based on the coherency between the first and second uplink transmissions, as described above with respect to block 806.

Optionally, the base station 1700 may comprise a transmission module configured to transmit, to the terminal device, a signaling about whether and/or how to perform the coherent transmissions over time. The first reception module 1702 may be configured to receive, from the terminal device, the first uplink transmission of the first signal on the physical channel in the first time instant in the first set of subcarriers, based on the transmitted signaling. The second reception module 1704 may be configured to receive, from the terminal device, the second uplink transmission of the second signal on the physical channel in the second time instant in the second set of subcarriers, based on the transmitted signaling.

FIG. 18 is a block diagram showing a terminal device according to an embodiment of the disclosure. As shown, the terminal device 1800 comprises a determination module 1802 and a transmission module 1804. The determination module 1802 may be configured to determine a frequency hopping pattern for an uplink transmission, based on a signaling received from a base station, as described above with respect to block 1102. The transmission module 1804 may be configured to transmit a plurality of signals on a physical channel in a plurality of time instants based on the frequency hopping pattern, as described above with respect to block 1104.

FIG. 19 is a block diagram showing a base station according to an embodiment of the disclosure. As shown, the base station 1900 comprises a transmission module 1902 and a reception module 1904. The transmission module 1902 may be configured to transmit, to a terminal device, a signaling by which a frequency hopping pattern for an uplink transmission can be determined, as described above with respect to block 1202. The reception module 1904 may be configured to receive, from the terminal device, a plurality of signals on a physical channel in a plurality of time instants based on the frequency hopping pattern, as described above with respect to block 1204.

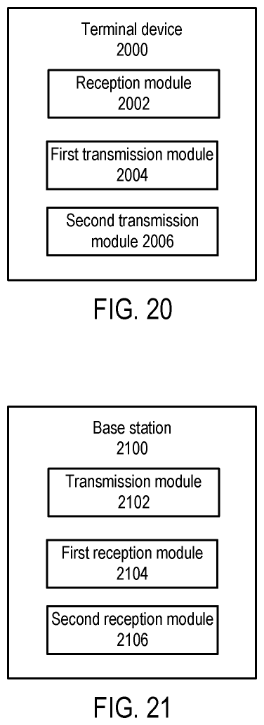

FIG. 20 is a block diagram showing a terminal device according to an embodiment of the disclosure. As shown, the terminal device 2000 comprises a reception module 2002, a first transmission module 2004 and a second transmission module 2006. The reception module 2002 may be configured to receive, from a base station, a signaling indicating DMRS configurations for an uplink transmission that is to be performed in multiple time instants, as described above with respect to block 1302. The DMRS configurations may indicate that a number of DMRS symbols to be transmitted in part of the multiple time instants is zero or less than normal. The first transmission module 2004 may be configured to transmit multiple signals on a physical channel in the multiple time instants, as described above with respect to block 1304. The second transmission module 2006 may be configured to transmit DMRS symbols on the physical channel based on the DMRS configurations, as described above with respect to block 1306.

FIG. 21 is a block diagram showing a base station according to an embodiment of the disclosure. As shown, the base station 2100 comprises a transmission module 2102, a first reception module 2104 and a second reception module 2106. The transmission module 2102 may be configured to transmit, to a terminal device, a signaling indicating DMRS configurations for an uplink transmission that is to be performed in multiple time instants, as described above with respect to block 1402. The DMRS configurations may indicate that a number of DMRS symbols to be transmitted in part of the multiple time instants is zero or less than normal. The first reception module 2104 may be configured to receive multiple signals on a physical channel in the multiple time instants, as described above with respect to block 1404. The second reception module 2106 may be configured to receive DMRS symbols on the physical channel based on the DMRS configurations, as described above with respect to block 1406. The modules described above may be implemented by hardware, or software, or a combination of both.

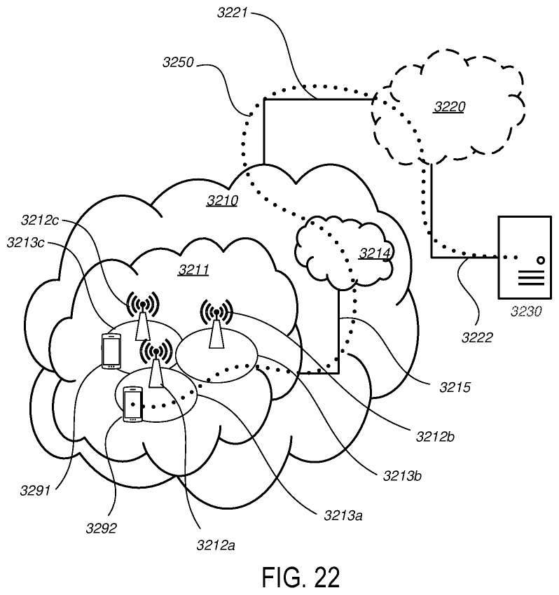

With reference to FIG. 22, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 22 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

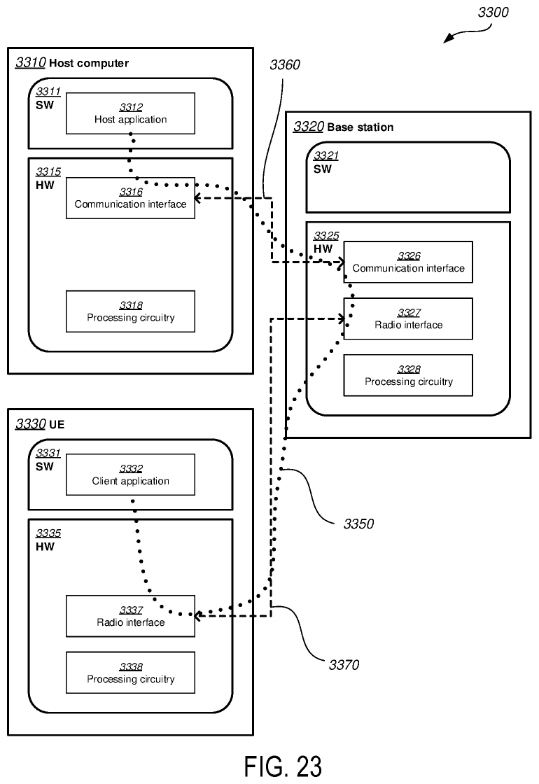

Example implementations, in accordance with an embodiment, of the UE, base station and host computer discussed in the preceding paragraphs will now be described with reference to FIG. 23. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 23) served by base station 3320. Communication interface 3326 may be configured to facilitate connection 3360 to host computer 3310. Connection 3360 may be direct or it may pass through a core network (not shown in FIG. 23) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. Its hardware 3335 may include radio interface 3337 configured to set up and maintain wireless connection 3370 with a base station serving a coverage area in which UE 3330 is currently located. Hardware 3335 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 23 may be similar or identical to host computer 3230, one of base stations 3212a, 3212b, 3212c and one of UEs 3291, 3292 of FIG. 22, respectively. This is to say, the inner workings of these entities may be as shown in FIG. 23 and independently, the surrounding network topology may be that of FIG. 22.

In FIG. 23, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may improve the latency and thereby provide benefits such as reduced user waiting time.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

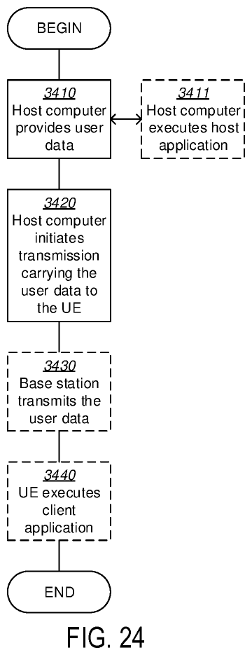

FIG. 24 is a flowchart illustrating a method implemented in a communication system, in accordance with one embodiment. The communication system includes a host computer, a base station and a UE which may be those described with reference to FIGS. 22 and 23. For simplicity of the present disclosure, only drawing references to FIG. 24 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

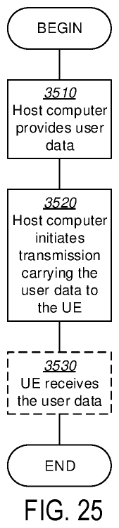

FIG. 25 is a flowchart illustrating a method implemented in a communication system, in accordance with one embodiment. The communication system includes a host computer, a base station and a UE which may be those described with reference to FIGS. 22 and 23. For simplicity of the present disclosure, only drawing references to FIG. 25 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

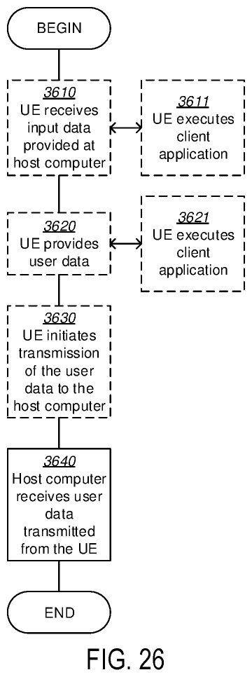

FIG. 26 is a flowchart illustrating a method implemented in a communication system, in accordance with one embodiment. The communication system includes a host computer, a base station and a UE which may be those described with reference to FIGS. 22 and 23. For simplicity of the present disclosure, only drawing references to FIG. 26 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

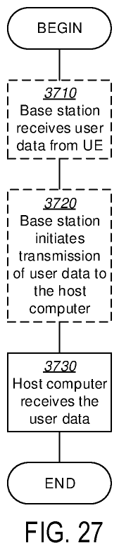

FIG. 27 is a flowchart illustrating a method implemented in a communication system, in accordance with one embodiment. The communication system includes a host computer, a base station and a UE which may be those described with reference to FIGS. 22 and 23. For simplicity of the present disclosure, only drawing references to FIG. 27 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

According to an aspect of the disclosure, there is provided a method implemented in a communication system including a host computer, a base station and a terminal device. The method may comprise, at the host computer, providing user data. The method may further comprise, at the host computer, initiating a transmission carrying the user data to the terminal device via a cellular network comprising the base station. The base station may transmit, to a terminal device, a signaling about whether and/or how to perform coherent transmissions over time. The base station may further receive, from the terminal device, a first uplink transmission of a first signal on a physical channel in a first time instant in a first set of subcarriers, based on the transmitted signaling. The base station may further receive, from the terminal device, a second uplink transmission of a second signal on the physical channel in a second time instant in a second set of subcarriers, based on the transmitted signaling. The first uplink transmission and the second uplink transmission may be coherent with each other. The base station may further process the first and second uplink transmissions based on the coherency between the first and second uplink transmissions.

In an embodiment of the disclosure, the method may further comprise, at the base station, transmitting the user data.

In an embodiment of the disclosure, the user data may be provided at the host computer by executing a host application. The method may further comprise, at the terminal device, executing a client application associated with the host application.

According to another aspect of the disclosure, there is provided a communication system including a host computer comprising processing circuitry configured to provide user data and a communication interface configured to forward the user data to a cellular network for transmission to a terminal device. The cellular network may comprise a base station having a radio interface and processing circuitry. The base station's processing circuitry may be configured to transmit, to a terminal device, a signaling about whether and/or how to perform coherent transmissions over time. The base station's processing circuitry may be further configured to receive, from the terminal device, a first uplink transmission of a first signal on a physical channel in a first time instant in a first set of subcarriers, based on the transmitted signaling. The base station's processing circuitry may be further configured to receive, from the terminal device, a second uplink transmission of a second signal on the physical channel in a second time instant in a second set of subcarriers, based on the transmitted signaling. The first uplink transmission and the second uplink transmission may be coherent with each other. The base station's processing circuitry may be further configured to process the first and second uplink transmissions based on the coherency between the first and second uplink transmissions.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application, thereby providing the user data. The terminal device may comprise processing circuitry configured to execute a client application associated with the host application.

According to yet another aspect of the disclosure, there is provided a method implemented in a communication system including a host computer, a base station and a terminal device. The method may comprise, at the host computer, providing user data. The method may further comprise, at the host computer, initiating a transmission carrying the user data to the terminal device via a cellular network comprising the base station. The terminal device may receive, from a base station, a signaling about whether and/or how to perform coherent transmissions over time. The terminal device may further transmit a first signal on a physical channel in a first time instant in a first set of subcarriers, based on the received signaling. The terminal device may further transmit a second signal on the physical channel in a second time instant in a second set of subcarriers, based on the received signaling. The transmission in the first time instant and the transmission in the second time instant may be coherent with each other.

In an embodiment of the disclosure, the method may further comprise, at the terminal device, receiving the user data from the base station.

According to yet another aspect of the disclosure, there is provided a communication system including a host computer comprising processing circuitry configured to provide user data and a communication interface configured to forward user data to a cellular network for transmission to a terminal device. The terminal device may comprise a radio interface and processing circuitry. The processing circuitry of the terminal device may be configured to receive, from a base station, a signaling about whether and/or how to perform coherent transmissions over time. The processing circuitry of the terminal device may be configured to transmit a first signal on a physical channel in a first time instant in a first set of subcarriers, based on the received signaling. The processing circuitry of the terminal device may be further configured to transmit a second signal on the physical channel in a second time instant in a second set of subcarriers, based on the received signaling. The transmission in the first time instant and the transmission in the second time instant may be coherent with each other.

In an embodiment of the disclosure, the communication system may further include the terminal device.

In an embodiment of the disclosure, the cellular network may further include the base station configured to communicate with the terminal device.

In an embodiment of the disclosure, the processing circuitry of the host computer may be configured to execute a host application, thereby providing the user data. The processing circuitry of the terminal device may be configured to execute a client application associated with the host application.

According to yet another aspect of the disclosure, there is provided a method implemented in a communication system including a host computer, a base station and a terminal device. The method may comprise, at the host computer, receiving user data transmitted to the base station from the terminal device. The terminal device may receive, from a base station, a signaling about whether and/or how to perform coherent transmissions over time. The terminal device may further transmit a first signal on a physical channel in a first time instant in a first set of subcarriers, based on the received signaling. The terminal device may further transmit a second signal on the physical channel in a second time instant in a second set of subcarriers, based on the received signaling. The transmission in the first time instant and the transmission in the second time instant may be coherent with each other.

In an embodiment of the disclosure, the method may further comprise, at the terminal device, providing the user data to the base station.

In an embodiment of the disclosure, the method may further comprise, at the terminal device, executing a client application, thereby providing the user data to be transmitted. The method may further comprise, at the host computer, executing a host application associated with the client application.

In an embodiment of the disclosure, the method may further comprise, at the terminal device, executing a client application. The method may further comprise, at the terminal device, receiving input data to the client application. The input data may be provided at the host computer by executing a host application associated with the client application. The user data to be transmitted may be provided by the client application in response to the input data.

According to yet another aspect of the disclosure, there is provided a communication system including a host computer comprising a communication interface configured to receive user data originating from a transmission from a terminal device to abase station. The terminal device may comprise a radio interface and processing circuitry. The processing circuitry of the terminal device may be configured to receive, from a base station, a signaling about whether and/or how to perform coherent transmissions over time. The processing circuitry of the terminal device may be further configured to transmit a first signal on a physical channel in a first time instant in a first set of subcarriers, based on the received signaling. The processing circuitry of the terminal device may be further configured to transmit a second signal on the physical channel in a second time instant in a second set of subcarriers, based on the received signaling. The transmission in the first time instant and the transmission in the second time instant may be coherent with each other.

In an embodiment of the disclosure, the communication system may further include the terminal device.

In an embodiment of the disclosure, the communication system may further include the base station. The base station may comprise a radio interface configured to communicate with the terminal device and a communication interface configured to forward to the host computer the user data carried by a transmission from the terminal device to the base station.

In an embodiment of the disclosure, the processing circuitry of the host computer may be configured to execute a host application. The processing circuitry of the terminal device may be configured to execute a client application associated with the host application, thereby providing the user data.

In an embodiment of the disclosure, the processing circuitry of the host computer may be configured to execute a host application, thereby providing request data. The processing circuitry of the terminal device may be configured to execute a client application associated with the host application, thereby providing the user data in response to the request data.

According to yet another aspect of the disclosure, there is provided a method implemented in a communication system including a host computer, a base station and a terminal device. The method may comprise, at the host computer, receiving, from the base station, user data originating from a transmission which the base station has received from the terminal device. The base station may transmit, to a terminal device, a signaling about whether and/or how to perform coherent transmissions over time. The base station may further receive, from the terminal device, a first uplink transmission of a first signal on a physical channel in a first time instant in a first set of subcarriers, based on the transmitted signaling. The base station may further receive, from the terminal device, a second uplink transmission of a second signal on the physical channel in a second time instant in a second set of subcarriers, based on the transmitted signaling. The first uplink transmission and the second uplink transmission may be coherent with each other. The base station may further process the first and second uplink transmissions based on the coherency between the first and second uplink transmissions.

In an embodiment of the disclosure, the method may further comprise, at the base station, receiving the user data from the terminal device.

In an embodiment of the disclosure, the method may further comprise, at the base station, initiating a transmission of the received user data to the host computer.

According to yet another aspect of the disclosure, there is provided a communication system including a host computer comprising a communication interface configured to receive user data originating from a transmission from a terminal device to a base station. The base station may comprise a radio interface and processing circuitry. The base station's processing circuitry may be configured to transmit, to a terminal device, a signaling about whether and/or how to perform coherent transmissions over time. The base station's processing circuitry may be further configured to receive, from the terminal device, a first uplink transmission of a first signal on a physical channel in a first time instant in a first set of subcarriers, based on the transmitted signaling. The base station's processing circuitry may be further configured to receive, from the terminal device, a second uplink transmission of a second signal on the physical channel in a second time instant in a second set of subcarriers, based on the transmitted signaling. The first uplink transmission and the second uplink transmission may be coherent with each other. The base station's processing circuitry may be further configured to process the first and second uplink transmissions based on the coherency between the first and second uplink transmissions.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application. The terminal device may be configured to execute a client application associated with the host application, thereby providing the user data to be received by the host computer.

According to yet another aspect of the disclosure, there is provided a method implemented in a communication system including a host computer, a base station and a terminal device. The method may comprise, at the host computer, providing user data. The method may further comprise, at the host computer, initiating a transmission carrying the user data to the terminal device via a cellular network comprising the base station. The base station may transmit, to a terminal device, a signaling by which a frequency hopping pattern for an uplink transmission can be determined. The base station may further receive, from the terminal device, a plurality of signals on a physical channel in a plurality of time instants based on the frequency hopping pattern.

In an embodiment of the disclosure, the method may further comprise, at the base station, transmitting the user data.

In an embodiment of the disclosure, the user data may be provided at the host computer by executing a host application. The method may further comprise, at the terminal device, executing a client application associated with the host application.

According to yet another aspect of the disclosure, there is provided a communication system including a host computer comprising processing circuitry configured to provide user data and a communication interface configured to forward the user data to a cellular network for transmission to a terminal device. The cellular network may comprise a base station having a radio interface and processing circuitry. The base station's processing circuitry may be configured to transmit, to a terminal device, a signaling by which a frequency hopping pattern for an uplink transmission can be determined. The base station's processing circuitry may be further configured to receive, from the terminal device, a plurality of signals on a physical channel in a plurality of time instants based on the frequency hopping pattern.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application, thereby providing the user data. The terminal device may comprise processing circuitry configured to execute a client application associated with the host application.

According to yet another aspect of the disclosure, there is provided a method implemented in a communication system including a host computer, a base station and a terminal device. The method may comprise, at the host computer, providing user data. The method may further comprise, at the host computer, initiating a transmission carrying the user data to the terminal device via a cellular network comprising the base station. The terminal device may determine a frequency hopping pattern for an uplink transmission, based on a signaling received from a base station. The terminal device may further transmit a plurality of signals on a physical channel in a plurality of time instants based on the frequency hopping pattern.

In an embodiment of the disclosure, the method may further comprise, at the terminal device, receiving the user data from the base station.

According to yet another aspect of the disclosure, there is provided a communication system including a host computer comprising processing circuitry configured to provide user data and a communication interface configured to forward user data to a cellular network for transmission to a terminal device. The terminal device may comprise a radio interface and processing circuitry. The processing circuitry of the terminal device may be configured to determine a frequency hopping pattern for an uplink transmission, based on a signaling received from a base station. The processing circuitry of the terminal device may be further configured to transmit a plurality of signals on a physical channel in a plurality of time instants based on the frequency hopping pattern.

In an embodiment of the disclosure, the communication system may further include the terminal device.

In an embodiment of the disclosure, the cellular network may further include a base station configured to communicate with the terminal device.

In an embodiment of the disclosure, the processing circuitry of the host computer may be configured to execute a host application, thereby providing the user data. The processing circuitry of the terminal device may be configured to execute a client application associated with the host application.

According to yet another aspect of the disclosure, there is provided a method implemented in a communication system including a host computer, a base station and a terminal device. The method may comprise, at the host computer, receiving user data transmitted to the base station from the terminal device. The terminal device may determine a frequency hopping pattern for an uplink transmission, based on a signaling received from a base station. The terminal device may further transmit a plurality of signals on a physical channel in a plurality of time instants based on the frequency hopping pattern.

In an embodiment of the disclosure, the method may further comprise, at the terminal device, providing the user data to the base station.

In an embodiment of the disclosure, the method may further comprise, at the terminal device, executing a client application, thereby providing the user data to be transmitted. The method may further comprise, at the host computer, executing a host application associated with the client application.

In an embodiment of the disclosure, the method may further comprise, at the terminal device, executing a client application. The method may further comprise, at the terminal device, receiving input data to the client application. The input data may be provided at the host computer by executing a host application associated with the client application. The user data to be transmitted may be provided by the client application in response to the input data.

According to yet another aspect of the disclosure, there is provided a communication system including a host computer comprising a communication interface configured to receive user data originating from a transmission from a terminal device to abase station. The terminal device may comprise a radio interface and processing circuitry. The processing circuitry of the terminal device may be configured to determine a frequency hopping pattern for an uplink transmission, based on a signaling received from a base station. The processing circuitry of the terminal device may be further configured to transmit a plurality of signals on a physical channel in a plurality of time instants based on the frequency hopping pattern.

In an embodiment of the disclosure, the communication system may further include the terminal device.

In an embodiment of the disclosure, the communication system may further include the base station. The base station may comprise a radio interface configured to communicate with the terminal device and a communication interface configured to forward to the host computer the user data carried by a transmission from the terminal device to the base station.

In an embodiment of the disclosure, the processing circuitry of the host computer may be configured to execute a host application. The processing circuitry of the terminal device may be configured to execute a client application associated with the host application, thereby providing the user data.

In an embodiment of the disclosure, the processing circuitry of the host computer may be configured to execute a host application, thereby providing request data. The processing circuitry of the terminal device may be configured to execute a client application associated with the host application, thereby providing the user data in response to the request data.

According to yet another aspect of the disclosure, there is provided a method implemented in a communication system including a host computer, a base station and a terminal device. The method may comprise, at the host computer, receiving, from the base station, user data originating from a transmission which the base station has received from the terminal device. The base station may transmit, to a terminal device, a signaling by which a frequency hopping pattern for an uplink transmission can be determined. The base station may further receive, from the terminal device, a plurality of signals on a physical channel in a plurality of time instants based on the frequency hopping pattern.

In an embodiment of the disclosure, the method may further comprise, at the base station, receiving the user data from the terminal device.

In an embodiment of the disclosure, the method may further comprise, at the base station, initiating a transmission of the received user data to the host computer.

According to yet another aspect of the disclosure, there is provided a communication system including a host computer comprising a communication interface configured to receive user data originating from a transmission from a terminal device to a base station. The base station may comprise a radio interface and processing circuitry. The base station's processing circuitry may be configured to transmit, to a terminal device, a signaling by which a frequency hopping pattern for an uplink transmission can be determined. The base station's processing circuitry may be further configured to receive, from the terminal device, a plurality of signals on a physical channel in a plurality of time instants based on the frequency hopping pattern.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application. The terminal device may be configured to execute a client application associated with the host application, thereby providing the user data to be received by the host computer.

According to yet another aspect of the disclosure, there is provided a method implemented in a communication system including a host computer, a base station and a terminal device. The method may comprise, at the host computer, providing user data. The method may further comprise, at the host computer, initiating a transmission carrying the user data to the terminal device via a cellular network comprising the base station. The base station may transmit, to a terminal device, a signaling indicating DMRS configurations for an uplink transmission that is to be performed in multiple time instants. The DMRS configurations may indicate that a number of DMRS symbols to be transmitted in part of the multiple time instants is zero or less than normal. The base station may further receive multiple signals on a physical channel in the multiple time instants. The base station may further receive DMRS symbols on the physical channel based on the DMRS configurations.

In an embodiment of the disclosure, the method may further comprise, at the base station, transmitting the user data.

In an embodiment of the disclosure, the user data may be provided at the host computer by executing a host application. The method may further comprise, at the terminal device, executing a client application associated with the host application.

According to yet another aspect of the disclosure, there is provided a communication system including a host computer comprising processing circuitry configured to provide user data and a communication interface configured to forward the user data to a cellular network for transmission to a terminal device. The cellular network may comprise a base station having a radio interface and processing circuitry. The base station's processing circuitry may be configured to transmit, to a terminal device, a signaling indicating DMRS configurations for an uplink transmission that is to be performed in multiple time instants. The DMRS configurations may indicate that a number of DMRS symbols to be transmitted in part of the multiple time instants is zero or less than normal. The base station's processing circuitry may be further configured to receive multiple signals on a physical channel in the multiple time instants. The base station's processing circuitry may be further configured to receive DMRS symbols on the physical channel based on the DMRS configurations.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application, thereby providing the user data. The terminal device may comprise processing circuitry configured to execute a client application associated with the host application.

According to yet another aspect of the disclosure, there is provided a method implemented in a communication system including a host computer, a base station and a terminal device. The method may comprise, at the host computer, providing user data. The method may further comprise, at the host computer, initiating a transmission carrying the user data to the terminal device via a cellular network comprising the base station. The terminal device may receive, from a base station, a signaling indicating DMRS configurations for an uplink transmission that is to be performed in multiple time instants. The DMRS configurations may indicate that a number of DMRS symbols to be transmitted in part of the multiple time instants is zero or less than normal. The terminal device may further transmit multiple signals on a physical channel in the multiple time instants. The terminal device may further transmit DMRS symbols on the physical channel based on the DMRS configurations.

In an embodiment of the disclosure, the method may further comprise, at the terminal device, receiving the user data from the base station.

According to yet another aspect of the disclosure, there is provided a communication system including a host computer comprising processing circuitry configured to provide user data and a communication interface configured to forward user data to a cellular network for transmission to a terminal device. The terminal device may comprise a radio interface and processing circuitry. The processing circuitry of the terminal device may be configured to receive, from a base station, a signaling indicating DMRS configurations for an uplink transmission that is to be performed in multiple time instants. The DMRS configurations may indicate that a number of DMRS symbols to be transmitted in part of the multiple time instants is zero or less than normal. The processing circuitry of the terminal device may be further configured to transmit multiple signals on a physical channel in the multiple time instants. The processing circuitry of the terminal device may be further configured to transmit DMRS symbols on the physical channel based on the DMRS configurations.

In an embodiment of the disclosure, the communication system may further include the terminal device.

In an embodiment of the disclosure, the cellular network may further include a base station configured to communicate with the terminal device.

In an embodiment of the disclosure, the processing circuitry of the host computer may be configured to execute a host application, thereby providing the user data. The processing circuitry of the terminal device may be configured to execute a client application associated with the host application.

According to yet another aspect of the disclosure, there is provided a method implemented in a communication system including a host computer, a base station and a terminal device. The method may comprise, at the host computer, receiving user data transmitted to the base station from the terminal device. The terminal device may receive, from abase station, a signaling indicating DMRS configurations for an uplink transmission that is to be performed in multiple time instants. The DMRS configurations may indicate that a number of DMRS symbols to be transmitted in part of the multiple time instants is zero or less than normal. The terminal device may further transmit multiple signals on a physical channel in the multiple time instants. The terminal device may further transmit DMRS symbols on the physical channel based on the DMRS configurations.

In an embodiment of the disclosure, the method may further comprise, at the terminal device, providing the user data to the base station.

In an embodiment of the disclosure, the method may further comprise, at the terminal device, executing a client application, thereby providing the user data to be transmitted. The method may further comprise, at the host computer, executing a host application associated with the client application.

In an embodiment of the disclosure, the method may further comprise, at the terminal device, executing a client application. The method may further comprise, at the terminal device, receiving input data to the client application. The input data may be provided at the host computer by executing a host application associated with the client application. The user data to be transmitted may be provided by the client application in response to the input data.

According to yet another aspect of the disclosure, there is provided a communication system including a host computer comprising a communication interface configured to receive user data originating from a transmission from a terminal device to abase station. The terminal device may comprise a radio interface and processing circuitry. The processing circuitry of the terminal device may be configured to receive, from a base station, a signaling indicating DMRS configurations for an uplink transmission that is to be performed in multiple time instants. The DMRS configurations may indicate that a number of DMRS symbols to be transmitted in part of the multiple time instants is zero or less than normal. The processing circuitry of the terminal device may be further configured to transmit multiple signals on a physical channel in the multiple time instants. The processing circuitry of the terminal device may be further configured to transmit DMRS symbols on the physical channel based on the DMRS configurations.

In an embodiment of the disclosure, the communication system may further include the terminal device.

In an embodiment of the disclosure, the communication system may further include the base station. The base station may comprise a radio interface configured to communicate with the terminal device and a communication interface configured to forward to the host computer the user data carried by a transmission from the terminal device to the base station.

In an embodiment of the disclosure, the processing circuitry of the host computer may be configured to execute a host application. The processing circuitry of the terminal device may be configured to execute a client application associated with the host application, thereby providing the user data.

In an embodiment of the disclosure, the processing circuitry of the host computer may be configured to execute a host application, thereby providing request data. The processing circuitry of the terminal device may be configured to execute a client application associated with the host application, thereby providing the user data in response to the request data.

According to yet another aspect of the disclosure, there is provided a method implemented in a communication system including a host computer, a base station and a terminal device. The method may comprise, at the host computer, receiving, from the base station, user data originating from a transmission which the base station has received from the terminal device. The base station may transmit, to a terminal device, a signaling indicating DMRS configurations for an uplink transmission that is to be performed in multiple time instants. The DMRS configurations may indicate that a number of DMRS symbols to be transmitted in part of the multiple time instants is zero or less than normal. The base station may further receive multiple signals on a physical channel in the multiple time instants. The base station may further receive DMRS symbols on the physical channel based on the DMRS configurations.

In an embodiment of the disclosure, the method may further comprise, at the base station, receiving the user data from the terminal device.

In an embodiment of the disclosure, the method may further comprise, at the base station, initiating a transmission of the received user data to the host computer.

According to yet another aspect of the disclosure, there is provided a communication system including a host computer comprising a communication interface configured to receive user data originating from a transmission from a terminal device to a base station. The base station may comprise a radio interface and processing circuitry. The base station's processing circuitry may be configured to transmit, to a terminal device, a signaling indicating DMRS configurations for an uplink transmission that is to be performed in multiple time instants. The DMRS configurations may indicate that a number of DMRS symbols to be transmitted in part of the multiple time instants is zero or less than normal. The base station's processing circuitry may be further configured to receive multiple signals on a physical channel in the multiple time instants. The base station's processing circuitry may be further configured to receive DMRS symbols on the physical channel based on the DMRS configurations.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application. The terminal device may be configured to execute a client application associated with the host application, thereby providing the user data to be received by the host computer.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described. It should be noted that two blocks shown in succession in the figures may, in fact, be executed substantially concurrently, or the blocks may sometimes be executed in the reverse order, depending upon the functionality involved.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a terminal device, comprising:
receiving, from a base station, a signaling about how to perform coherent transmissions over time;
transmitting, based on the received signaling, a first signal on a physical channel in a first time instant in a first set of subcarriers; and
transmitting, based on the received signaling, a second signal on the physical channel in a second time instant in a second set of subcarriers,
wherein transmission in the first time instant and transmission in the second time instant are coherent with each other.

2. The method according to claim 1, wherein the second signal is a repetition of the first transmitted signal.

3. The method according to claim 1, wherein the transmission in the first time instant and the transmission in the second time instant are performed on a same antenna port.

4. (canceled)

5. The method according to claim 1, further comprising:
transmitting, to the base station, capability information of the terminal device regarding a support of the coherent transmissions over time.

6. The method according to claim 5, wherein the capability information indicates at least one of:
a number of time instants over which the terminal device is capable of supporting the coherent transmissions over time; and
a condition under which the terminal device is capable of supporting the coherent transmissions over time.

7. The method according to claim 6, wherein the condition is related to one or more of following factors:
allocated frequency resource;
hopping frequency;
transmission power;
uplink transmission beam or spatial transmission filter;
phase rotation;
subcarrier spacing;
demodulation reference signal, DMRS, configuration;
a number of repetitions of the first transmitted signal; and
a speed of the terminal device.

8. The method according to claim 1, wherein the received signaling indicates one or more of:
whether to perform the coherent transmissions over time;
in which time instants the coherent transmissions over time are to be performed;
a number of contiguous time instants in which the coherent transmissions over time are to be performed; and
at least one parameter with which the coherent transmissions over time are to be performed.

9. The method according to claim 1, wherein a difference in phase, a difference in phase error, an error of phase difference, or any combination thereof, between each of the subcarriers in the second set and each of the subcarriers in the first set is smaller than or equal to a predetermined threshold.

10. The method according to claim 1, wherein the transmission in the first time instant and the transmission in the second time instant are performed with at least one of:
a same transmission power;
a same spatial transmission filter; and
a same uplink precoder.

11-15. (canceled)

16. A method performed by a base station, comprising:
transmitting, to a terminal device, a signaling about how to perform coherent transmissions over time;
receiving, from the terminal device, a first uplink transmission of a first signal on a physical channel in a first time instant in a first set of subcarriers, based on the transmitted signaling;
receiving, from the terminal device, a second uplink transmission of a second signal on the physical channel in a second time instant in a second set of subcarriers, based on the transmitted signaling, wherein the first uplink transmission and the second uplink transmission are coherent with each other; and
processing the first and second uplink transmissions based on the coherency between the first and second uplink transmissions.

17. The method according to claim 16, wherein the second signal is a repetition of the first signal.

18. The method according to claim 16, wherein the first uplink transmission and the second uplink transmission are from a same antenna port of the terminal device.

19. (canceled)

20. The method according to claim 16, wherein the first uplink transmission and the second uplink transmission are coherent with each other in terms of at least one of phase, transmission power and beam.

21. The method according to claim 16, further comprising:
receiving, from the terminal device, capability information of the terminal device regarding a support of the coherent transmissions over time.

22. The method according to claim 21, wherein the capability information indicates at least one of:
a number of time instants over which the terminal device is capable of supporting the coherent transmissions over time; and
a condition under which the terminal device is capable of supporting the coherent transmissions over time.

23. The method according to claim 22, wherein the condition is related to one or more of following factors:
allocated frequency resource;
hopping frequency;
transmission power;
uplink transmission beam or spatial transmission filter;
phase rotation;
subcarrier spacing;
demodulation reference signal, DMRS, configuration;
a number of repetitions of the first signal; and
a speed of the terminal device.

24. The method according to claim 16, wherein the transmitted signaling indicates one or more of:
whether to perform the coherent transmissions over time;
in which time instants the coherent transmissions over time are to be performed;
a number of contiguous time instants in which the coherent transmissions over time are to be performed; and
at least one parameter with which the coherent transmissions over time are to be performed.

25. The method according to claim 24, wherein the at least one parameter comprises one or more of:
a same transmission power;
a same spatial transmission filter; and
a same uplink precoder.

26. The method according to claim 16, wherein a difference in phase, a difference in phase error, an error of phase difference, or any combination thereof, between each of the subcarriers in the second set and each of the subcarriers in the first set is smaller than or equal to a predetermined threshold.

27-45. (canceled)

46. A terminal device comprising:
at least one processor; and
at least one memory, the at least one memory containing instructions which, when executed by the at least one processor, cause the terminal device to:
receive, from a base station, a signaling about how to perform coherent transmissions over time;
transmit, based on the received signaling, a first signal on a physical channel in a first time instant in a first set of subcarriers; and
transmit, based on the received signaling, a second signal on the physical channel in a second time instant in a second set of subcarriers, wherein the transmission in the first time instant and the transmission in the second time instant are coherent with each other.

47-54. (canceled)
